(19) United States
(12) Patent Application Publication
(10) Pub. No.: US 2017/0002116 A1
(43) Pub. Date: Jan. 5, 2017

(54) Articles of Reclaimed Polypropylene Compositions

(71) Applicant: The Procter & Gamble Company, Cincinnati, OH (US)

(72) Inventors: John Moncrief Layman, Liberty Township, OH (US); Maggie Gunnerson, Cincinnati, OH (US); Eric Bryan Bond, Maineville, OH (US); Andrew Eric Neltner, Loveland, OH (US); Jennifer Elizabeth Hosmer, Fairfield, OH (US)

(21) Appl. No.: 15/190,243

(22) Filed: Jun. 23, 2016

Related U.S. Application Data
(60) Provisional application No. 62/186,520, filed on Jun. 30, 2015.

(51) Int. Cl. C08F 10/06; D01F 6/30; D01F 6/06

(52) U.S. Cl. CPC C08F 10/06; D01F 6/06; D01F 6/30

(57) ABSTRACT

An article is disclosed that comprises at least about 95 weight percent reclaimed isotactic polypropylene base resin. The base resin comprises less than about 10 ppm Al, less than about 5 ppm Ti, and less than about 5 ppm Zn. The article is substantially free of odor and the base resin has a contrast ratio opacity of less than about 15%.

### FIELD OF THE INVENTION

The present invention generally relates to articles comprising up to 100% of a reclaimed polypropylene composition. More specifically, this invention relates to pellets, molded articles, fibers, nonwovens, and films made from a composition of reclaimed polypropylene originating from post-consumer and/or post-industrial recycled polypropylene. The articles made from a reclaimed polypropylene composition are substantially free of odor and heavy metal contamination and comparable to articles made from virgin polypropylene.

### BACKGROUND OF THE INVENTION

Polymers, especially synthetic plastics, are ubiquitous in daily life due to their relatively low production costs and good balance of material properties. Synthetic plastics are used in a wide variety of applications, such as packaging, automotive components, medical devices, and consumer goods. To meet the high demand of these applications, tens of billions of pounds of synthetic plastics are produced globally on an annual basis. The overwhelming majority of synthetic plastics are produced from increasingly scarce fossil sources, such as petroleum and natural gas. Additionally, the manufacturing of synthetic plastics from fossil sources produces CO₂ as a by-product.

The ubiquitous use of synthetic plastics has consequently resulted in millions of tons of plastic waste being generated every year. While the majority of plastic waste is landfilled via municipal solid waste programs, a significant portion of plastic waste is found in the environment as litter, which is unsightly and potentially harmful to ecosystems. Plastic waste is often washed into river systems and ultimately out to sea.

Plastics recycling has emerged as one solution to mitigate the issues associated with the wide-spread usage of plastics. Recovering and re-using plastics diverts waste from landfills and reduces the demand for virgin plastics made from fossil-based resources, which consequently reduces greenhouse gas emissions. In developed regions, such as the United States and the European Union, rates of plastics recycling are increasing due to greater awareness by consumers, businesses, and industrial manufacturing operations. The majority of recycled materials, including plastics, are mixed into a single stream which is collected and processed by a material recovery facility (MRF). At the MRF, materials are sorted, washed, and packaged for resale. Plastics can be sorted into individual materials, such as high-density polyethylene (HDPE) or poly(ethylene terephthalate) (PET), or mixed streams of other common plastics, such as polypropylene (PP), low-density polyethylene (LDPE), poly(vinyl chloride) (PVC), polystyrene (PS), polycarbonate (PC), and polyamides (PA). The single or mixed streams can then be further sorted, washed, and reprocessed into a pellet that is suitable for re-use in plastics processing, for example blow and injection molding.

Though recycled plastics are sorted into predominately uniform streams and are washed with aqueous and/or caustic solutions, the final reprocessed pellet often remains highly contaminated with unwanted waste impurities, such as spoiled food residue and residual perfume components. In addition, recycled plastic pellets, except for those from recycled beverage containers, are darkly colored due to the mixture of dyes and pigments commonly used to colorize plastic articles. While there are some applications that are insensitive to color and contamination (for example black plastic paint containers and concealed automotive components), the majority of applications require non-colored pellets. The need for high quality, “virgin-like” recycled resin is especially important for food and drug contact applications, such as food packaging. In addition to being contaminated with impurities and mixed colorants, many recycled resin products are often heterogeneous in chemical composition and may contain a significant amount of polymeric contamination, such as polyethylene (PE) contamination in recycled PP and vice versa.

Mechanical recycling, also known as secondary recycling, is the process of converting recycled plastic waste into a re-usable form for subsequent manufacturing. A more detailed review of mechanical recycling and other plastics recovery processes are described in S. M. Al-Salem, P. Lettieri, J. Baeyens, “Recycling and recovery routes of plastic solid waste (PSW): A review”, Waste Management, Volume 29, Issue 10, October 2009, Pages 2625-2643, ISSN 0956-053X. While advances in mechanical recycling technology have improved the quality of recycled polymers to some degree, there are fundamental limitations of mechanical decontamination approaches, such as the physical entrapment of pigments within a polymer matrix. Thus, even with the improvements in mechanical recycling technology, the dark color and high levels of chemical contamination in currently available recycled plastic waste prevents broader usage of recycled resins by the plastics industry.

To overcome the fundamental limitations of mechanical recycling, there have been many methods developed to purify contaminated polymers via chemical approaches, or chemical recycling. Most of these methods use solvents to decontaminate and purify polymers. The use of solvents enables the extraction of impurities and the dissolution of polymers, which further enables alternative separation technologies.

For example, U.S. Pat. No. 7,935,736 describes a method for recycling polyester from polyester-containing waste using a solvent to dissolve the polyester prior to cleaning. The '736 patent also describes the need to use a precipitant to recover the polyester from the solvent.

In another example, U.S. Pat. No. 6,555,588 describes a method to produce a polypropylene blend from a plastic mixture comprised of other polymers. The '588 patent describes the extraction of contaminants from a polymer at a temperature below the dissolution temperature of the polymer in the selected solvent, such as hexane, for a specified residence period. The '588 patent further describes increasing the temperature of the solvent (or a second solvent) to dissolve the polymer prior to filtration. The '588 patent yet further describes the use of shearing or flow to precipitate polypropylene from solution. The polypropylene blend described in the '588 patent contained polyethylene contamination up to 5.6 wt %.

In another example, European Patent Application No. 849,312 (translated from German to English) describes a process to obtain purified polyolefins from a polyolefin-containing plastic mixture or a polyolefin-containing waste. The '312 patent application describes the extraction of polyolefin mixtures or wastes with a hydrocarbon fraction of gasoline or diesel fuel with a boiling point above 90° C. at temperatures between 90° C. and the boiling point of the hydrocarbon solvent. The '312 patent application further describes contacting a hot polyolefin solution with bleaching clay and/or activated carbon to remove foreign components from the solution. The '312 patent yet further describes cooling the solution to temperatures below 70° C. to crystallize the polyolefin and then removing adhering solvent by heating the polyolefin above the melting point of the polyolefin, or evaporating the adhering solvent in a vacuum or passing a gas stream through the polyolefin precipitate, and/or extraction of the solvent with an alcohol or ketone that boils below the melting point of the polyolefin.

In another example, U.S. Pat. No. 5,198,471 describes a method for separating polymers from a physically commingled solid mixture (for example waste plastics) containing a plurality of polymers using a solvent at a first lower temperature to form a first single phase solution and a remaining solid component. The '471 patent further describes heating the solvent to higher temperatures to dissolve additional polymers that were not solubilized at the first lower temperature. The '471 patent describes filtration of insoluble polymer components.

In another example, U.S. Pat. No. 5,233,021 describes a method of extracting pure polymeric components from a multi-component structure (for example waste carpeting) by dissolving each component at an appropriate temperature and pressure in a supercritical fluid and then varying the temperature and/or pressure to extract particular components in sequence. However, similar to the '471 patent, the '021 patent only describes filtration of undissolved components.

In another example, U.S. Pat. No. 5,739,270 describes a method and apparatus for continuously separating a polymeric component of a plastic from contaminants and other components of the plastic using a co-solvent and a working fluid. The co-solvent at least partially dissolves the polymer and the second fluid (that is in a liquid, critical, or supercritical state) solubilizes components from the polymer and precipitates some of the dissolved polymer from the co-solvent. The '270 patent further describes the step of filtering the thermoplastic-co-solvent (with or without the working fluid) to remove particulate contaminants, such as glass particles.

The known solvent-based methods to purify contaminated polymers, as described above, do not produce “virgin-like” polymers. In the previous methods, co-dissolution and thus cross contamination of other polymers often occurs. If adsorbent is used, a filtration and/or centrifugation step is often employed to remove the used adsorbent from solution. In addition, isolation processes to remove solvent, such as heating, vacuum evaporation, and/or precipitation using a precipitating chemical are used to produce a polymer free of residual solvent. Thus, articles manufactured from known reclaimed polypropylene compositions, especially articles made from 100% post-consumer recycled polypropylene, often 1) are difficult to color match to a desired color target, 2) have high opacities, 3) have malodor, 4) have unacceptably high levels of heavy metal contamination, 5) have unacceptably high levels of polymeric contamination, and 6) have inferior physical properties when compared to the same articles manufactured from virgin polypropylene.

Accordingly, a need still exists for articles made from reclaimed polypropylene compositions with “virgin-like” properties that are comparable articles made from virgin polypropylene. The articles of the present invention are made of reclaimed polypropylene compositions produced by an improved solvent-based method disclosed herein. The articles, which may contain surprisingly high levels of post-consumer recycled polypropylene (up to 100%), are 1) essentially colorless or colorable to any color target that can be achieved with virgin propylene 2) have low opacities (in other words high translucency), 3) are essentially odorless, 4) are essentially free of heavy metal contamination (excluding heavy metals introduced during the manufacturing of the article), 5) are essentially free of polymeric contamination (i.e. polyethylene contamination in polypropylene), and 6) have physical properties (i.e. tensile strength, impact strength, etc.) comparable to articles manufactured from virgin polypropylene.

### SUMMARY OF THE INVENTION

An article is disclosed that comprises at least about 95 weight percent reclaimed isotactic polypropylene base resin. The base resin comprises less than about 10 ppm Al, less than about 5 ppm Ti, and less than about 5 ppm Zn. The article is substantially free of odor and the base resin has a contrast ratio opacity of less than about 15%. In one embodiment, the article comprises post-consumer recycle derived reclaimed polypropylene. In another embodiment, the article comprises post-industrial recycle derived reclaimed polypropylene.

In one embodiment, the article comprises less than about 10 ppm Na. In another embodiment, the article comprises less than about 20 ppm Ca.

In one embodiment, the article comprises less than about 2 ppm Cr. In another embodiment, the article comprises less than about 7 ppm Fe.

In one embodiment, the article comprises less than about 100 ppb Ni. In another embodiment, the article comprises less than about 50 ppb Cu.

In one embodiment, the article comprises less than about 10 ppb Cd. In another embodiment, the article comprises less than about 10 ppb Pb.

In one embodiment, the article has a contrast ratio opacity of less than about 10%. In another embodiment, the article has an odor intensity of less than about 2.

In one embodiment, the article is a fiber. In another embodiment, the article is a nonwoven web comprising fibers.

In one embodiment, the article is a film. In another embodiment, the article is a fluid pervious web formed from film.

In one embodiment, the article is a molded article. In another embodiment, the molded article is in the form of a bottle, container, tub, closure, cap, lid, handle, dispenser, pump, part assembly, tampon applicator, sheet, pipe, or profile extrusion.

In one embodiment, the molded article is made by a method comprising compression molding. In another embodiment, the molded article is made by a method comprising extrusion.

In one embodiment, the molded article is made by a method comprising blow molding. In another embodiment, the molded article is made by a method comprising injection molding.

In one embodiment, an article is disclosed that comprises at least about 95 weight percent reclaimed isotactic polypropylene base resin. The base resin comprises less than about 10 ppm Al, less than about 5 ppm Ti, and less than about 5 ppm Zn. The article is substantially color-free, substantially free of odor and the base resin has a contrast ratio opacity of less than about 15%.

Additional features of the invention may become apparent to those skilled in the art from a review of the following detailed description, taken in conjunction with the examples.

### BRIEF DESCRIPTION OF THE DRAWINGS

FIG. 1 is a block flow diagram showing the major steps of an embodiment to manufacture articles of reclaimed polypropylene compositions.

FIG. 2 is a calibration curve for the calculation of polyethylene content in polypropylene using enthalpy values from DSC measurements.

FIG. 3 is a schematic of the experimental apparatus used in the examples.

FIG. 4 is a bar chart of the opacity and odor intensity of the examples.

### DETAILED DESCRIPTION OF THE INVENTION

### I. Definitions

As used herein, the term “reclaimed polymer” refers to a polymer used for a previous purpose and then recovered for further processing.

As used herein, the term “reclaimed polypropylene” refers to polypropylene used for a previous purpose and then recovered for further processing.

As used herein, the term “post-consumer” refers to a source of material that originates after the end consumer has used the material in a consumer good or product.

As used herein, the term “post-consumer recycle” (PCR) refers to a material that is produced after the end consumer has used the material and has disposed of the material in a waste stream.

As used herein, the term “post-industrial” refers to a source of a material that originates during the manufacture of a good or product.

As used herein, the term “fluid solvent” refers to a substance that may exist in the liquid state under specified conditions of temperature and pressure. In some embodiments the fluid solvent may be a predominantly homogenous chemical composition of one molecule or isomer, while in other embodiments, the fluid solvent may be a mixture of several different molecular compositions or isomers. Further, in some embodiments of the present invention, the term “fluid solvent” may also apply to substances that are at, near, or above the critical temperature and critical pressure (critical point) of that substance. It is well known to those having ordinary skill in the art that substances above the critical point of that substance are known as “supercritical fluids” which do not have the typical physical properties (i.e. density) of a liquid.

As used herein, the term “dissolved” means at least partial incorporation of a solute (polymeric or non-polymeric) in a solvent at the molecular level. Further, the thermodynamic stability of the solute/solvent solution can be described by the following equation 1:

ΔGₘᵢₓ=ΔHₘ−TΔSₘᵢₓ (I)

where ΔGₘᵢₓ is the Gibbs free energy change of mixing of a solute with a solvent, ΔHₘᵢₓ is the enthalpy change of mixing, T is the absolute temperature, and ΔSₘᵢₓ is the entropy of mixing. To maintain a stable solution of a solute in a solvent, the Gibbs free energy must be negative and at a minimum. Thus, any combination of solute and solvent that minimize a negative Gibbs free energy at appropriate temperatures and pressures can be used for the present invention.

As used herein, the term “standard boiling point” refers to the boiling temperature at an absolute pressure of exactly 100 kPa (1 bar, 14.5 psia, 0.9869 atm) as established by the International Union of Pure and Applied Chemistry (IUPAC).

As used herein, the term “substantially free of odor” means odor comparable in both character and intensity to virgin polypropylene as detected by a normally functioning human nose.

As used herein, the term “contrast ratio opacity” refers to the percentage of opaqueness of a 1 mm thick object, as based on the following equation:

Percent Opacity=(L*Value of the object measured against a background/L*″Value of the object measured against a white background)×100

As used herein, the term “polypropylene solution” refers to a solution of polypropylene dissolved in a solvent. The polypropylene solution may contain undissolved matter and thus the polypropylene solution may also be a “slurry” of undissolved matter suspended in a solution of polypropylene dissolved in a solvent.

As used herein, the term “solid media” refers to a substance that exists in the solid state under the conditions of use. The solid media may be crystalline, semi-crystalline, or amorphous. The solid media may be granular and may be supplied in different shapes (i.e. spheres, cylinders, pellets, etc.). If the solid media is granular, the particle size and particle size distribution of solid media may be defined by the mesh size used to classify the granular media. An example of standard mesh size designations can be found in the American Society for Testing and Material (ASTM) standard ASTM E11 “Standard Specification for Woven Wire Test Sieve Cloth and Test Sieves.” The solid media may also be a non-woven fibrous mat or a woven textile.

As used herein, the term “purer polypropylene solution” refers to a polypropylene solution having fewer contaminants relative to the same polypropylene solution prior to a purification step.

As used herein, the term “virgin-like” means essentially contaminant-free, pigment-free, odor-free, homogenous, and similar in properties to virgin polypropylene.

As used herein, the term “primarily polypropylene copolymer” refers a copolymer with greater than 70 mol % of propylene repeating units.

As used herein, the term “substantially color free” refers to an article that is clear or colorless, often referred to as “natural” in color and similar in color to virgin polypropylene.

As used herein, the term “base resin” refers to a polymeric resin used to form an article that has not yet been combined with an additive or additive mixture (i.e. colorant masterbatch) that may be used during the manufacture of the article. The base resin is often combined with an additive or additive mixture simultaneously during the manufacture of an article.

### II. Compositions Prepared Via a Method for Purifying Contaminated Polypropylene

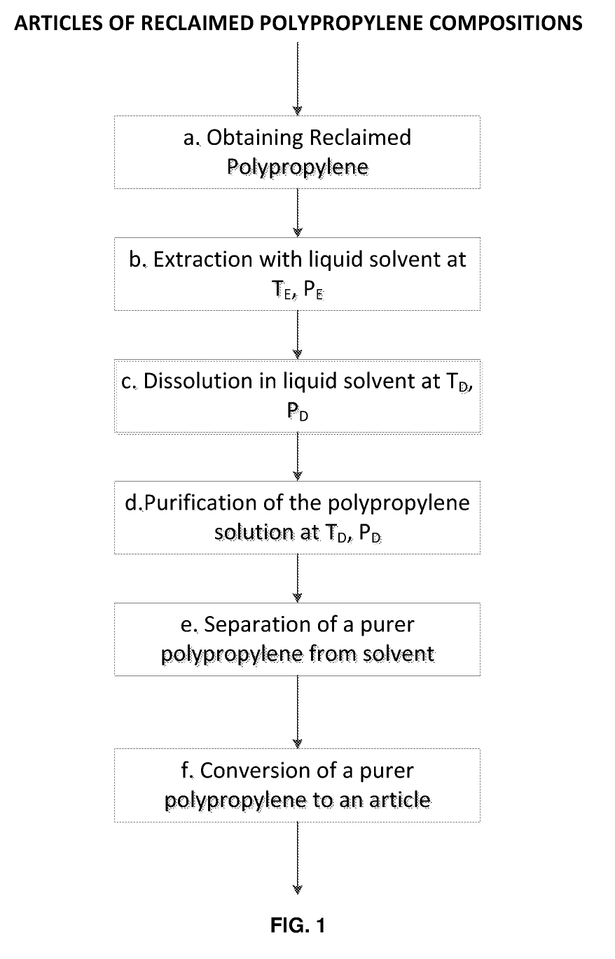

Compositions disclosed herein include reclaimed isotactic polypropylene that has been purified to a virgin-like state in terms of color, odor, opacity, heavy metal contamination, and polymeric contamination. Surprisingly, it has been found that certain fluid solvents, which in a preferred embodiment exhibit temperature and pressure-dependent solubility for polypropylene, when used in a relatively simple process can be used to purify contaminated polypropylene, especially reclaimed or recycled polypropylene, to a near virgin-like quality. This process, exemplified in FIG. 1, comprises 1) obtaining a reclaimed polypropylene (step a in FIG. 1), followed by 2) extracting the polypropylene with a fluid solvent at an extraction temperature (T_{E}) and at an extraction pressure (P_{E}) (step b in FIG. 1), followed by 3) dissolution of the polypropylene in a fluid solvent at a dissolution temperature (T_{D}) and at a dissolution pressure (P_{D}) (step c in FIG. 1), followed by 4) contacting the dissolved polypropylene solution with solid media at a dissolution temperature (T_{D}) and at a dissolution pressure (P_{D}) (step d in FIG. 1), followed by separation of the polypropylene from the fluid solvent (step e in FIG. 1). In one embodiment, the purified polypropylene, which may be sourced from post-consumer waste streams, is essentially contaminant-free, pigment-free, odor-free, homogenous, and similar in properties to virgin polypropylene. Furthermore, in a preferred embodiment, the physical properties of the fluid solvent of the present invention may enable more energy efficient methods for separation of the fluid solvent from the purified polypropylene.

### Reclaimed Polypropylene

In one embodiment, compositions prepared via a method for purifying polypropylene includes obtaining reclaimed polypropylene. For the purposes of the present invention, the reclaimed polypropylene is sourced from post-consumer, post-industrial, post-commercial, and/or other special waste streams. For example, post-consumer waste polypropylene can be derived from curbside recycle streams where end-consumers place used polypropylene from packages and products into a designated bin for collection by a waste hauler or recycler. Post-consumer waste polypropylene can also be derived from in-store “take-back” programs where the consumer brings waste polypropylene into a store and places the waste polypropylene in a designated collection bin. An example of post-industrial waste polypropylene can be waste polypropylene produced during the manufacture or shipment of a good or product that are collected as unusable material by the manufacturer (i.e. trim scraps, out of specification material, start up scrap). An example of waste polypropylene from a special waste stream can be waste polypropylene derived from the recycling of electronic waste, also known as e-waste. Another example of waste polypropylene from a special waste stream can be waste polypropylene derived from the recycling of automobiles. Another example of waste polypropylene from a special waste stream can be waste polypropylene derived from the recycling of used carpeting and textiles.

For the purposes of the present invention, the reclaimed polypropylene is derived from a homogenous stream of reclaimed polypropylene or as part of a mixed stream of several different polymer compositions. The reclaimed polypropylene may be a homopolymer of propylene monomers or a primarily polypropylene copolymer with other monomers, such as ethylene, other alpha-olefins, or other monomers that may be apparent to those having ordinary skill in the art. In one embodiment, the reclaimed polypropylene is isotactic polypropylene.

The reclaimed polypropylene may also contain various pigments, dyes, process aides, stabilizing additives, fillers, and other performance additives that were added to the polypropylene during polymerization or conversion of the original polypropylene to the final form of an article. Non-limiting examples of pigments are organic pigments, such as copper phthalocyanine, inorganic pigments, such as titanium dioxide, and other pigments that may be apparent to those having ordinary skill in the art. A non-limiting example of an organic dye is Basic Yellow 51. Non-limiting examples of process aides are antistatic agents, such as glycerol monostearate and slip-promoting agents, such as erucamide. A non-limiting example of a stabilizing additive is octadecyl-3-(3,5-di-tert.butyl-4-hydroxyphenyl)-propionate. Non-limiting examples of fillers are calcium carbonate, talc, and glass fibers.

### Solvent

The fluid solvent used to prepare reclaimed polypropylene compositions a standard boiling point less than about 70° C. Pressurization maintains the solvent, which has a standard boiling point below the operating temperature range of the method to purify reclaimed polypropylene, in a state in which there is little or no solvent vapor. In one embodiment, the fluid solvent with a standard boiling point less than about 70° C. is selected from the group consisting of carbon dioxide, ketones, alcohols, ethers, esters, alkenes, alkanes, and mixtures thereof. Non-limiting examples of fluid solvents with standard boing points less than about 70° C. are carbon dioxide, acetone, methanol, dimethyl ether, diethyl ether, ethyl methyl ether, tetrahydrofuran, methyl acetate, ethylene, propylene, 1-butene, 2-butene, isobutylene, 1-pentene, 2-pentene, branched isomers of pentene, 1-hexene, 2-hexene, methane, ethane, propane, n-butane, isobutane, n-pentane, isopentane, neopentane, n-hexane, isomers of isohexane, and other substances that may be apparent to those having ordinary skill in the art.

The selection of the appropriate solvent or solvent mixture will depend on the source of reclaimed polypropylene as well as the composition of other polymers that may be present with the reclaimed polypropylene. Further, the selection of the solvent will dictate the temperature and pressure ranges used to perform the steps of a method to purify reclaimed polypropylene. A review of polymer phase behavior in pressurized solvents at various temperatures is provided in the following reference: McHugh et al. (1999) Chem. Rev. 99:565-602.

### Extraction

In one embodiment, compositions prepared via a method for purifying polypropylene includes contacting a reclaimed polypropylene with a fluid solvent at a temperature and at a pressure wherein the polypropylene is essentially insoluble in the fluid solvent. Although not wishing to be bound by any theory, applicants believe that the temperature and pressure-dependent solubility can be controlled in such a way to prevent the fluid solvent from fully solubilizing the polypropylene, however, the fluid solvent can diffuse into the polypropylene and extract any extractable contamination. The extractable contamination may be residual processing aides added to the polypropylene, residual product formulations which contacted the polypropylene, such as perfumes and flavors, dyes, and any other extractable material that may have been intentionally added or unintentionally became incorporated into the polypropylene, for example, during waste collection and subsequent accumulation with other waste materials.

In one embodiment, the controlled extraction may be accomplished by fixing the temperature of the polypropylene/fluid solvent system and then controlling the pressure below a pressure, or pressure range, where the polypropylene dissolves in the fluid solvent. In another embodiment, the controlled extraction is accomplished by fixing the pressure of the polypropylene/solvent system and then controlling the temperature below a temperature, or temperature range where the polypropylene dissolves in the fluid solvent. The temperature and pressure-controlled extraction of the polypropylene with a fluid solvent uses a suitable pressure vessel and may be configured in a way that allows for continuous extraction of the polypropylene with the fluid solvent. In one embodiment, the pressure vessel may be a continuous liquid-liquid extraction column where molten polypropylene is pumped into one end of the extraction column and the fluid solvent is pumped into the same or the opposite end of the extraction column. In another embodiment, the fluid containing extracted contamination is removed from the process. In another embodiment, the fluid containing extracted contamination is purified, recovered, and recycled for use in the extraction step or a different step in the process. In one embodiment, the extraction may be performed as a batch method, wherein the reclaimed polypropylene is fixed in a pressure vessel and the fluid solvent is continuously pumped through the fixed polypropylene phase. The extraction time or the amount of fluid solvent used will depend on the desired purity of the final purer polypropylene and the amount of extractable contamination in the starting reclaimed polypropylene. In another embodiment, the fluid containing extracted contamination is contacted with solid media in a separate step as described in the “Purification” section below. In another embodiment, compositions prepared via a method for purifying reclaimed polypropylene includes contacting a reclaimed polypropylene with a fluid solvent at a temperature and at a pressure wherein the polypropylene is molten and in the liquid state. In another embodiment, the reclaimed polypropylene is contacted with the fluid solvent at a temperature and at a pressure wherein the polypropylene is in the solid state.

In one embodiment, compositions prepared via a method for purifying reclaimed polypropylene includes contacting polypropylene with a fluid solvent at a temperature and a pressure wherein the polypropylene remains essentially undissolved. In another embodiment, compositions are prepared by contacting polypropylene with n-butane at a temperature from about 80° C. to about 220° C. In another embodiment, compositions are prepared by contacting polypropylene with n-butane at a temperature from about 100° C. to about 200° C. In another embodiment, compositions are prepared by contacting polypropylene with n-butane at a temperature from about 130° C. to about 180° C. In another embodiment, compositions are prepared by contacting polypropylene with n-butane at a pressure from about 150 psig (1.03 MPa) to about 3,000 psig (20.68 MPa). In another embodiment, compositions are prepared by contacting polypropylene with n-butane at a pressure from about 1,000 psig (6.89 MPa) to about 2,750 psig (18.96 MPa).

In another embodiment, compositions are prepared by contacting polypropylene with n-butane at a pressure from about 1,500 psig (10.34 MPa) to about 2,500 psig (17.24 MPa).

In another embodiment, compositions are prepared by contacting polypropylene with propane at a temperature from about 80° C. to about 220° C. In another embodiment, compositions are prepared by contacting polypropylene with propane at a temperature from about 100° C. to about 200° C. In another embodiment, compositions are prepared by contacting polypropylene with propane at a temperature from about 130° C. to about 180° C. In another embodiment, compositions are prepared by contacting polypropylene with propane at a pressure from about 200 psig (1.38 MPa) to about 8,000 psig (55.16 MPa). In another embodiment, compositions are prepared by contacting polypropylene with propane at a pressure from about 1,000 psig (6.89 MPa) to about 6,000 psig (41.37 MPa). In another embodiment, compositions are prepared by contacting polypropylene with propane at a pressure from about 2,000 psig (13.79 MPa) to about 4,000 psig (27.58 MPa).

### Dissolution

In one embodiment, compositions of reclaimed polypropylene are prepared by dissolving the reclaimed polypropylene in a fluid solvent at a temperature and at a pressure wherein the polypropylene is dissolved in the fluid solvent. Although not wishing to be bound by any theory, applicants believe that the temperature and pressure can be controlled in such a way to enable thermodynamically favorable dissolution of the reclaimed polypropylene in a fluid solvent. Furthermore, the temperature and pressure can be controlled in such a way to enable dissolution of polypropylene while not dissolving other polymers or polymer mixtures. This controllable dissolution enables the separation of polypropylene from polymer mixtures.

In one embodiment of the present invention, compositions are prepared by dissolving contaminated reclaimed polypropylene in a solvent that does not dissolve the contaminants under the same conditions of temperature and pressure. The contaminants may include pigments, fillers, dirt, and other polymers. These contaminants are released from the reclaimed polypropylene upon dissolution and then removed from the polypropylene solution via a subsequent solid-liquid separation step.

In one embodiment, compositions are prepared by dissolving polypropylene in a fluid solvent at a temperature and a pressure wherein the polypropylene is dissolved in the fluid solvent. In another embodiment, compositions are prepared by dissolving polypropylene in n-butane at a temperature from about 90° C. to about 220° C. In another embodiment, compositions are prepared by dissolving polypropylene in n-butane at a temperature from about 100° C. to about 200° C. In another embodiment, compositions are prepared by dissolving polypropylene in n-butane at a temperature from about 130° C. to about 180° C. In another embodiment, compositions are prepared by dissolving polypropylene in n-butane at a pressure from about 350 psig (2.41 MPa) to about 4,000 psig (27.58 MPa). In another embodiment, compositions are prepared by dissolving polypropylene in n-butane at a pressure from about 1,000 psig (6.89 MPa) to about 3,500 psig (24.13 MPa). In another embodiment, compositions are prepared by dissolving polypropylene in n-butane at a pressure from about 2,000 psig (13.79 MPa) to about 3,000 psig (20.68 MPa).

In another embodiment, compositions are prepared by dissolving polypropylene in propane at a temperature from about 90° C. to about 220° C. In another embodiment, compositions are prepared by dissolving polypropylene in propane at a temperature from about 100° C. to about 200° C. In another embodiment, compositions are prepared by dissolving polypropylene in propane at a temperature from about 130° C. to about 180° C. In another embodiment, compositions are prepared by dissolving polypropylene in propane at a pressure from about 2,000 psig (13.79 MPa) to about 8,000 psig (55.16 MPa). In another embodiment, compositions are prepared by dissolving polypropylene in propane at a pressure from about 3,000 psig (20.68 MPa) to about 6,000 psig (41.37 MPa). In another embodiment, compositions are prepared by dissolving polypropylene in propane at a pressure from about 3,500 psig (24.13 MPa) to about 5,000 psig (34.47 MPa).

### Purification

In one embodiment of the present invention, compositions are prepared by contacting a contaminated polypropylene solution with solid media at a temperature and at a pressure wherein the polypropylene remains dissolved in the fluid solvent. The solid media used to prepare compositions of the present invention is any solid material that removes at least some of the contamination from a solution of reclaimed polypropylene dissolved in a fluid solvent. Although not wishing to be bound by any theory, the applicants believe that solid media removes contamination by a variety of mechanisms. Non-limiting examples of possible mechanisms includes: adsorption, absorption, size exclusion, ion exclusion, ion exchange, and other mechanisms that may be apparent to those having ordinary skill in the art. Furthermore, the pigments and other contaminants commonly found in reclaimed polypropylene may be polar compounds and may preferentially interact with the solid media, which may also be at least slightly polar. The polar-polar interactions are especially favorable when non-polar solvents, such as alkanes, are used as the fluid solvent.

In one embodiment, the solid media used to prepare compositions of the present invention is selected from the group consisting of inorganic substances, carbon-based substances, or mixtures thereof. Useful examples of inorganic substances include oxides of silica, oxides of aluminum, oxides of iron, aluminum silicates, magnesium silicates, amorphous volcanic glasses, silica, silica gel, diatomite, sand, quartz, reclaimed glass, alumina, perlite, fuller's earth, bentonite, and mixtures thereof. Useful examples of carbon-based substances include anthracite coal, carbon black, coke, activated carbon, cellulose, and mixtures thereof. In another embodiment, the solid media is recycled glass.

In one embodiment, the solid media is contacted with the polypropylene in a vessel for a specified amount of time while the solid media is agitated. In another embodiment, the solid media is removed from the purer polypropylene solution via a solid-liquid separation step. Non-limiting examples of solid-liquid separation steps include filtration, decantation, centrifugation, and settling. In another embodiment, the contaminated polypropylene solution is passed through a stationary bed of solid media. In another embodiment, the height or length of the stationary bed of solid media used to prepare compositions of the present invention is greater than 5 cm. In another embodiment, the height or length of the stationary bed of solid media is greater than 10 cm. In another embodiment, the height or length of the stationary bed of solid media is greater than 20 cm. In another embodiment, the solid media is replaced as needed to maintain a desired purity of polypropylene. In yet another embodiment, the solid media is regenerated and re-used in the purification step. In another embodiment, the solid media is regenerated by fluidizing the solid media during a backwashing step.

In one embodiment, compositions are prepared by contacting a polypropylene/fluid solvent solution with solid media at a temperature and at a pressure wherein the polypropylene remains dissolved in the fluid solvent. In another embodiment, compositions are prepared by contacting a polypropylene/n-butane solution with solid media at a temperature from about 90° C. to about 220° C. In another embodiment, compositions are prepared by contacting a polypropylene/n-butane solution with solid media at a temperature from about 100° C. to about 200° C. In another embodiment, compositions are prepared by contacting a polypropylene/n-butane solution with solid media at a temperature from about 130° C. to about 180° C. In another embodiment, compositions are prepared by contacting a polypropylene/n-butane solution with solid media at a pressure from about 350 psig (2.41 MPa) to about 4,000 psig (27.58 MPa). In another embodiment, compositions are prepared by contacting a polypropylene/n-butane solution with solid media at a pressure from about 1,000 psig (6.89 MPa) to about 3,500 psig (24.13 MPa). In another embodiment, compositions are prepared by contacting a polypropylene/n-butane solution with solid media at a pressure from about 2,000 psig (13.79 MPa) to about 3,000 psig (20.68 MPa).

In another embodiment, compositions are prepared by contacting a polypropylene/propane solution with solid media at a temperature from about 90° C. to about 220° C. In another embodiment, compositions are prepared by contacting a polypropylene/propane solution with solid media at a temperature from about 100° C. to about 200° C. In another embodiment, compositions are prepared by contacting a polypropylene/propane solution with solid media at a temperature from about 130° C. to about 180° C. In another embodiment, compositions are prepared by contacting a polypropylene/propane solution with solid media at a pressure from about 2,000 psig (13.79 MPa) to about 8,000 psig (55.16 MPa). In another embodiment, compositions are prepared contacting a polypropylene/propane solution with solid media at a pressure from about 3,000 psig (20.68 MPa) to about 6,000 psig (41.37 MPa). In another embodiment, compositions are prepared by contacting a polypropylene/propane solution with solid media at a pressure from about 3,500 psig (24.13 MPa) to about 5,000 psig (34.47 MPa).

### Separation

In one embodiment of the present invention, compositions are prepared by separating the purer polypropylene from the fluid solvent at a temperature and at a pressure wherein the polypropylene precipitates from solution and is no longer dissolved in the fluid solvent. In another embodiment, the precipitation of the purer polypropylene from the fluid solvent is accomplished by reducing the pressure at a fixed temperature. In another embodiment, the precipitation of the purer polypropylene from the fluid solvent is accomplished by reducing the temperature at a fixed pressure. In another embodiment, the precipitation of the purer polypropylene from the fluid solvent is accomplished by increasing the temperature at a fixed pressure. In another embodiment, the precipitation of the purer polypropylene from the fluid solvent is accomplished by reducing both the temperature and pressure. The solvent can be partially or completely converted from the liquid to the vapor phase by controlling the temperature and pressure. In another embodiment, the precipitated polypropylene is separated from the fluid solvent without completely converting the fluid solvent into a 100% vapor phase by controlling the temperature and pressure of the solvent during the separation step. The separation of the precipitated purer polypropylene is accomplished by any method of liquid-liquid or liquid-solid separation. Non-limiting examples of liquid-liquid or liquid-solid separations include filtration, decantation, centrifugation, and settling.

In one embodiment, compositions are prepared by separating polypropylene from a polypropylene/fluid solvent solution at a temperature and at a pressure wherein the polypropylene precipitates from solution. In another embodiment, compositions are prepared by separating polypropylene from a polypropylene/n-butane solution at a temperature from about 0° C. to about 220° C. In another embodiment, compositions are prepared by separating polypropylene from a polypropylene/n-butane solution at a temperature from about 100° C. to about 200° C. In another embodiment, compositions are prepared by separating polypropylene from a polypropylene/n-butane solution at a temperature from about 130° C. to about 180° C. In another embodiment, compositions are prepared by separating polypropylene from a polypropylene/n-butane solution at a pressure from about 0 psig (0 MPa) to about 2,000 psig (13.79 MPa). In another embodiment, compositions are prepared by separating polypropylene from a polypropylene/n-butane solution at a pressure from about 50 psig (0.34 MPa) to about 1,500 psig (10.34 MPa). In another embodiment, compositions are prepared by separating polypropylene from a polypropylene/n-butane solution at a pressure from about 75 psig (0.52 MPa) to about 1,000 psig (6.89 MPa).

In another embodiment, compositions are prepared by separating polypropylene from a polypropylene/propane solution at a temperature from about −42° C. to about 220° C. In another embodiment, compositions are prepared by separating polypropylene from a polypropylene/propane solution at a temperature from about 0° C. to about 150° C. In another embodiment, compositions are prepared by separating polypropylene from a polypropylene/propane solution at a temperature from about 50° C. to about 130° C. In another embodiment, compositions are prepared by separating polypropylene from a polypropylene/propane solution at a pressure from about 0 psig (0 MPa) to about 6,000 psig (41.37 MPa). In another embodiment, compositions are prepared by separating polypropylene from a polypropylene/propane solution at a pressure from about 50 psig (0.34 MPa) to about 3,000 psig (20.68 MPa). In another embodiment, compositions are prepared by separating polypropylene from a polypropylene/propane solution at a pressure from about 75 psig (0.52 MPa) to about 1,000 psig (6.89 MPa).

### Additives

After purification, the reclaimed compositions disclosed herein can further include an additive or an additive mixture. The additive can be dispersed throughout the composition. Non-limiting examples of classes of additives contemplated in the compositions disclosed herein include antioxidants, colorants, nanoparticles, antistatic agents, processing aides, fillers, and combinations thereof. The compositions disclosed herein can contain a single additive or a mixture of additives. For example, both a antioxidant and a colorant (e.g., pigment and/or dye) can be present in the composition. The additive(s), when present, is/are present in a weight percent of about 0.05 wt % to about 20 wt %, or about 0.1 wt % to about 10 wt %. Specifically contemplated weight percentages include about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, and about 10 wt %.

Contemplated antioxidants include primary and secondary antioxidants such as hindered phenols, for example octadecyl-3-(3,5-di-tert.butyl-4-hydroxyphenyl)-propionate, hindered amines, thioesters, phosphites, phosphonites, and mixtures thereof.

A colorant can be a pigment or dye and can be inorganic, organic, or a combination thereof. Specific examples of pigments and dyes contemplated include pigment Yellow (C.I. 14), pigment Red (C.I. 48:3), pigment Blue (C.I. 15:4), pigment Black (C.I. 7), and combinations thereof. Specific contemplated dyes include water soluble ink colorants like direct dyes, acid dyes, base dyes, and various solvent soluble dyes. Examples include, but are not limited to, FD&C Blue 1 (C.I. 42090:2), D&C Red 6(C.I. 15850), D&C Red 7(C.I. 15850:1), D&C Red 9(C.I. 15585:1), D&C Red 21(C.I. 45380:2), D&C Red 22(C.I. 45380:3), D&C Red 27(C.I. 45410:1), D&C Red 28(C.I. 45410:2), D&C Red 30(C.I. 73360), D&C Red 33(C.I. 17200), D&C Red 34(C.I. 15880:1), and FD&C Yellow 5(C.I. 19140:1), FD&C Yellow 6(C.I. 15985:1), FD&C Yellow 10(C.I. 47005:1), D&C Orange 5(C.I. 45370:2), and combinations thereof. Other specific examples of pigments include carbon black, titanium dioxide, iron oxides, and copper phthalocyanine

Contemplated slip-promoting agents include compounds, such as oleamide and erucamide.

Additional contemplated additives include nucleating and clarifying agents for the thermoplastic polymer. Specific examples, suitable for polypropylene, for example, are benzoic acid and derivatives (e.g. sodium benzoate and lithium benzoate), as well as kaolin, talc and zinc glycerolate. Dibenzlidene sorbitol (DBS) is an example of a clarifying agent that can be used. Other nucleating agents that can be used are organocarboxylic acid salts, sodium phosphate and metal salts (for example aluminum dibenzoate) The nucleating or clarifying agents can be added in ranges from 20 parts per million (20 ppm) to 20,000 ppm, more preferred range of 200 ppm to 2000 ppm and the most preferred range from 1000 ppm to 1500 ppm. The addition of the nucleating agent can be used to improve the tensile and impact properties of the finished article.

Contemplated surfactants include anionic surfactants, amphoteric surfactants, or a combination of anionic and amphoteric surfactants, and combinations thereof, such as surfactants disclosed, for example, in U.S. Pat. Nos. 3,929,678 and 4,259,217 and in EP 414 549, WO93/08876 and WO93/08874.

Contemplated nanoparticles include metals, metal oxides, allotropes of carbon, clays, organically modified clays, sulfates, nitrides, hydroxides, oxy/hydroxides, particulate water-insoluble polymers, silicates, phosphates and carbonates. Examples include silicon dioxide, carbon black, graphite, graphene, fullerenes, expanded graphite, carbon nanotubes, talc, calcium carbonate, bentonite, montmorillonite, kaolin, zinc glycerolate, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe2O3, Fe3O4) and mixtures thereof. Nanoparticles can increase the strength, thermal stability, and/or abrasion resistance of the compositions disclosed herein, and can give the compositions electric properties.

It is contemplated to add waxes to the compositions as processing aids (i.e. to adjust the rheological properties of the composition) or to adjust the final properties of the article. Non-limiting examples of waxes contemplated in the compositions disclosed herein include beef tallow, castor wax, coconut wax, coconut seed wax, corn germ wax, cottonseed wax, fish wax, linseed wax, olive wax, oiticica wax, palm kernel wax, palm wax, palm seed wax, peanut wax, rapeseed wax, safflower wax, soybean wax, sperm wax, sunflower seed wax, tall wax, tung wax, whale wax, and combinations thereof.

Contemplated anti-static agents include glycerol monostearate and fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate.

Contemplated fillers include, but are not limited to inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used. Additionally, alkyd resins can also be added to the composition. Alkyd resins comprise a polyol, a polyacid or anhydride, and/or a fatty acid.

### III. Articles of Reclaimed Polypropylene Compositions

### Pellets

In one embodiment of the present invention, the article is in the form of pellets. Pellets of the purified reclaimed polypropylene composition can be formed after separation of the fluid solvent used for purification (step f in FIG. 1). The pellets can be formed by extruding a strand and pelletizing the strand via cutting or underwater pelletizing. In strand cutting, the composition is rapidly quenched (generally in a time period much less than 10 seconds) then cut into small pieces. In underwater pelletizing, the composition is cut into small pieces and simultaneously or immediately thereafter placed in the presence of a low temperature liquid that rapidly cools and solidifies the composition to form the pelletized article. Such pelletizing methods are well understood by the ordinarily skilled artisan. Pellet morphologies can be round or cylindrical, and can have no dimension larger than 15 mm, more preferably less than 10 mm, or no dimension larger than 5 mm.

### Molded Articles

The molded articles of the compositions as disclosed herein can be prepared using a variety of techniques, such as injection molding, blow molding, compression molding, or extrusion of pipes, tubes, profiles, or cables.

Injection molding of a composition as disclosed herein is a multi-step process by which the composition is heated until it is molten, then forced into a closed mold where it is shaped, and finally solidified by cooling. The composition is melt processed at melting temperatures of about 200° C. to minimize unwanted thermal degradation. Three common types of machines that are used in injection molding are ram, screw plasticator with injection, and reciprocating screw devices (see Encyclopedia of Polymer Science and Engineering, Vol. 8, pp. 102-138, John Wiley and Sons, New York, 1987 (“EPSE-3”).

A ram injection molding machine is composed of a cylinder, spreader, and plunger. The plunger forces the melt in the mold. A screw plasticator with a second stage injection consists of a plasticator, directional valve, a cylinder without a spreader, and a ram. After plastication by the screw, the ram forces the melt into the mold. A reciprocating screw injection machine is composed of a barrel and a screw. The screw rotates to melt and mix the material and then moves forward to force the melt into the mold.

An example of a suitable injection molding machine is the Engel Tiebarless ES 60 TL apparatus having a mold, a nozzle, and a barrel that is divided into zones wherein each zone is equipped with thermocouples and temperature-control units. The zones of the injection molding machine can be described as front, center, and rear zones whereby the pellets are introduced into the front zone under controlled temperature. The temperature of the nozzle, mold, and barrel components of the injection molding machine can vary according to the melt processing temperature of the compositions and the molds used, but will typically be in the following ranges: nozzle, 120-220° C.; front zone, 100-220° C.; center zone 100-200° C.; rear zone 60-160° C.; and mold, 5-50° C. Other typical processing conditions include an injection pressure of about 2100 kPa to about 13,790 kPa, a holding pressure of about 2800 kPa to about 11,030 kPa, a hold time of about 2 seconds to about 15 seconds, and an injection speed of from about 2 cm/sec to about 20 cm/sec. Examples of other suitable injection molding machines include Van Dorn Model 150-RS-8F, Battenfeld Model 1600, and Engel Model ES80.

Compression molding involves charging a quantity of a composition as disclosed herein in the lower half of an open die. The top and bottom halves of the die are brought together under pressure, and then molten composition conforms to the shape of the die. The mold is then cooled to harden the plastic.

Blow molding is used for producing bottles and other hollow objects (see EPSE-3). In this process, a tube of molten composition known as a parison is extruded into a closed, hollow mold. The parison is then expanded by a gas, thrusting the composition against the walls of a mold. Subsequent cooling hardens the plastic. The mold is then opened and the article removed.

Blow molding has a number of advantages over injection molding. The pressures used are much lower than injection molding. Blow molding can be typically accomplished at pressures of 25-100 psi (0.17-0.69 MPa) between the plastic and the mold surface. By comparison, injection molding pressures can reach 10,000 (68.95 MPa) to 20,000 psi (137.90 MPa) (see EPSE-3). In cases where the composition has a have molecular weights too high for easy flow through molds, blow molding is the technique of choice. High molecular weight polymers often have better properties than low molecular weight analogs, for example high molecular weight materials have greater resistance to environmental stress cracking. (see EPSE-3). It is possible to make extremely thin walls in products with blow molding. This means less composition is used, and solidification times are shorter, resulting in lower costs through material conservation and higher throughput. Another important feature of blow molding is that since it uses only a female mold, slight changes in extrusion conditions at the parison nozzle can vary wall thickness (see EPSE-3). This is an advantage with structures whose necessary wall thicknesses cannot be predicted in advance. Evaluation of articles of several thicknesses can be undertaken, and the thinnest, thus lightest and cheapest, article that meets specifications can be used.

Extrusion is used to form extruded articles, such as pipes, tubes, rods, cables, or profile shapes. Compositions are fed into a heating chamber and moved through the chamber by a continuously revolving screw. Single screw or twin screw extruders are commonly used for plastic extrusion. The composition is plasticated and conveyed through a pipe die head. A haul-off draws the pipe through the calibration and cooling section with a calibration die, a vacuum tank calibration unit and a cooling unit. Rigid pipes are cut to length while flexible pipes are wound. Profile extrusion may be carried out in a one step process. Extrusion procedures are further described in Hensen, F., Plastic Extrusion Technology, p 43-100.

The composition disclosed herein is suitable for producing container articles, such as personal care products, household cleaning products, and laundry detergent products, and packaging for such articles. Personal care products include cosmetics, hair care, skin care, and oral care products, i.e., shampoo, soap, tooth paste. Accordingly, further disclosed herein is product packaging, such as containers or bottles comprising the composition described herein. A container can refer to one or more elements of a container, e.g., body, cap, nozzle, handle, or a container in its entirety, e.g., body and cap.

The composition disclosed herein is suitable for use in hook and loop fastening systems. Hook and loop fastening systems have a female fastening material made of a fibrous material and a male fastening material having hooks configured to fasten to the fibrous material. These hook and loop systems can be used with various articles. For example, hook and loop fastening systems can be used in wearable absorbent articles such as diapers, training pants, incontinence undergarments, feminine sanitary pads, etc. (In various embodiments, wearable absorbent articles can be disposable or reusable.) Hook and loop fastening systems can also be used to fasten disposable cleaning cloths, disposable garments, medical wraps, and other articles.

A male fastening material includes hooks and a substrate. A male fastening material can include hooks having any shape such as a “J” shape, a “T” shape, or a mushroom shape, or any other shape known in the art. A male fastening material and the hooks thereon can be made by any suitable process, such as casting, molding, profile extrusion, or microreplication, as will be understood by one of ordinary skill in the art.

A female fastening material can be any fibrous material suitable for releasably engaging hooks of a male fastening material. Fibrous materials can take many forms, such as fabrics (e.g. wovens, knits, felts, nonwovens) textiles, composites, and others. Fibers in the fibrous materials can be configured with any size, shape, and length; such fibers can be made by any suitable process known in the art. Part, parts, or all of a female fastening material can be made from any of the natural or synthetic materials recited herein and/or any other suitable material suitable known in the art, along with any additives or processing aids recited herein or known in the art. A female fastening material can be incorporated into a product in various ways, such as a landing zone on a front-fastenable wearable absorbent article.

### Fibers

The fibers in the present invention may be monocomponent or multicomponent. The term “fiber” is defined as a solidified polymer shape with a length to thickness ratio of greater than 1,000. The monocomponent fibers of the present invention may also be multiconstituent. Constituent, as used herein, is defined as meaning the chemical species of matter or the material. Multiconstituent fiber, as used herein, is defined to mean a fiber containing more than one chemical species or material. Multiconstituent and alloyed polymers have the same meaning in the present invention and can be used interchangeably. Generally, fibers may be of monocomponent or multicomponent types. Component, as used herein, is defined as a separate part of the fiber that has a spatial relationship to another part of the fiber. The term multicomponent, as used herein, is defined as a fiber having more than one separate part in spatial relationship to one another. The term multicomponent includes bicomponent, which is defined as a fiber having two separate parts in a spatial relationship to one another. The different components of multicomponent fibers are arranged in substantially distinct regions across the cross-section of the fiber and extend continuously along the length of the fiber. Methods for making multicomponent fibers are well known in the art. Multicomponent fiber extrusion was well known in the 1960's. DuPont was a lead technology developer of multicomponent capability, with U.S. Pat. No. 3,244,785 and U.S. Pat. No. 3,704,971 providing a technology description of the technology used to make these fibers. “Bicomponent Fibers” by R. Jeffries from Merrow Publishing in 1971 laid a solid groundwork for bicomponent technology. More recent publications include “Taylor-Made Polypropylene and Bicomponent Fibers for the Nonwoven Industry,” Tappi Journal December 1991 (p 103) and “Advanced Fiber Spinning Technology” edited by Nakajima from Woodhead Publishing.

The nonwoven fabric formed in the present invention may contain multiple types of monocomponent fibers that are delivered from different extrusion systems through the same spinneret. The extrusion system, in this example, is a multicomponent extrusion system that delivers different polymers to separate capillaries. For instance, one extrusion system would deliver reclaimed polypropylene and the other a different polypropylene copolymer such that the different copolymer composition melts at different temperatures. In a second example, one extrusion system might deliver a polyethylene resin and the other reclaimed polypropylene.

Bicomponent and multicomponent fibers may be in a side-by-side, sheath-core (symmetric and eccentric), segmented pie, ribbon, islands-in-the-sea configuration, or any combination thereof. The sheath may be continuous or non-continuous around the core. Non-inclusive examples of exemplarily multicomponent fibers are disclosed in U.S. Pat. No. 6,746,766. The ratio of the weight of the sheath to the core is from about 5:95 to about 95:5. The fibers of the present invention may have different geometries that include, but are not limited to; round, elliptical, star shaped, trilobal, multilobal with 3-8 lobes, rectangular, H-shaped, C-shaped, I-shape, U-shaped and other various eccentricities. Hollow fibers can also be used. Preferred shapes are round, trilobal and H-shaped. The round and trilobal fiber shapes can also be hollow.

Sheath and core bicomponent fibers are preferred. In one preferred case, the component in the core may contain the reclaimed polypropylene, while the sheath does not. In this case the exposure to reclaimed polypropylene at the surface of the fiber is reduced or eliminated. In another preferred case, the sheath may contain the reclaimed polypropylene and the core does not. It should be understood that islands-in-a-sea bicomponent fibers are considered to be a type of sheath and core fiber, but with multiple cores. Segmented pie fibers (hollow and solid) are contemplated. For one example, to split regions that contain reclaimed polypropylene from regions that do not contain reclaimed polypropylene using segmented pie type of bicomponent fiber design. Splitting may occur during mechanical deformation, application of hydrodynamic forces or other suitable processes.

Tricomponent fibers are also contemplated. One example of a useful tricomponent fiber would be a three layered sheath/sheath/core fiber, where each component contains a different composition. For example, the core can be a blend of 10 melt flow polypropylene with reclaimed polypropylene. The middle layer sheath may be a blend of 25 melt flow polypropylene with reclaimed polypropylene and the outer layer may be straight 35 melt flow rate polypropylene. Another type of useful tricomponent fiber contemplated is a segmented pie type bicomponent design that also has a sheath.

A “highly attenuated fiber” is defined as a fiber having a high draw down ratio. The total fiber draw down ratio is defined as the ratio of the fiber at its maximum diameter (which is typically results immediately after exiting the capillary) to the final fiber diameter in its end use. The total fiber draw down ratio will be greater than 1.5, preferable greater than 5, more preferably greater than 10, and most preferably greater than 12. This is necessary to achieve the tactile properties and useful mechanical properties.

The fiber will have a diameter of less than 200 μm. The fiber diameter can be as low as 0.1 μm if the composition is being used to produce fine fibers. The fibers can be either essentially continuous or essentially discontinuous. Fibers commonly used to make spunbond nonwovens will have a diameter of from about 5 μm to about 30 μm, more preferably from 10 μm to about 20 μm and most preferred from 12 μm to about 18 μm. Fine fiber diameter will have a diameter from 0.1 μm to about 5 μm, preferably from 0.2 μm to about 3 μm and most preferred from 0.3 μm to about 2 μm Fiber diameter is controlled by die geometry, spinning speed or drawing speed, mass through-put, and blend composition and rheology.

The hydrophilicity and hydrophobicity of the fibers can be adjusted in the present invention. The base resin properties can have hydrophilic properties via the addition of materials to the base resin to render it hydrophilic. Exemplarily examples of additives include CIBA Irgasurf® family of additives. The fibers in the present invention can also be treated or coated after they are made to render them hydrophilic. Durable hydrophilicity is defined as maintaining hydrophilic characteristics after more than one fluid interaction. For example, if the sample being evaluated is tested for durable hydrophilicity, water can be poured on the sample and wetting observed. If the sample wets out it is initially hydrophilic. The sample is then completely rinsed with water and dried. The rinsing is best done by putting the sample in a large container and agitating for ten seconds and then drying. The sample after drying should also wet out when contacted again with water.

After the fiber is formed, the fiber may further be treated or the bonded fabric can be treated. A hydrophilic or hydrophobic finish can be added to adjust the surface energy and chemical nature of the fabric. For example, fibers that are hydrophobic may be treated with wetting agents to facilitate absorption of aqueous liquids. A bonded fabric can also be treated with a topical solution containing surfactants, pigments, slip agents, salt, or other materials to further adjust the surface properties of the fiber.

The fibers in the present invention can be crimped. Crimped fibers are generally produced in two methods. The first method is mechanical deformation of the fiber after it is already spun. Fibers are melt spun, drawn down to the final filament diameter and mechanically treated, generally through gears or a stuffer box that imparts either a two dimensional or three dimensional crimp. This method is used in producing most carded staple fibers. The second method for crimping fibers is to extrude multicomponent fibers that are capable of crimping in a spunlaid process. One of ordinary skill in the art would recognize that a number of methods of making bicomponent crimped spunbond fibers exist; however, for the present invention, three main techniques are considered for making crimped spunlaid nonwovens. The first is crimping that occurs in the spinline due to differential polymer crystallization in the spinline, a result of differences in polymer type, polymer molecular weight characteristics (e.g., molecular weight distribution) or additives content. A second method is differential shrinkage of the fibers after they have been spun into a spunlaid substrate. For instance, heating the spunlaid web can cause fibers to shrink due to differences in crystallinity in the as-spun fibers, for example during the thermal bonding process. A third method of causing crimping is to mechanically stretch the fibers or spunlaid web (generally for mechanical stretching the web has been bonded together). The mechanical stretching can expose differences in the stress-strain curve between the two polymer components, which can cause crimping.

The tensile strength of a fiber is approximately greater than 25 Mega Pascal (MPa). The fibers as disclosed herein have a tensile strength of greater than about 50 MPa, preferably greater than about 75 MPa, and more preferably greater than about 100 MPa. Tensile strength is measured using an Instron following a procedure described by ASTM standard D 3822-91 or an equivalent test.

The fibers as disclosed herein are not brittle and have a toughness of greater than 2 MPa, greater than 50 MPa, or greater than 100 MPa. Toughness is defined as the area under the stress-strain curve where the specimen gauge length is 25 mm with a strain rate of 50 mm per minute. Elasticity or extensibility of the fibers may also be desired.

The fibers as disclosed herein can be thermally bondable if enough thermoplastic polymer is present in the fiber or on the outside component of the fiber (i.e. sheath of a bicomponent). Thermally bondable fibers are best used in the pressurized heat and thru-air heat bonding methods.

The fibers of the present invention may be used to make nonwovens, among other suitable articles. Nonwoven articles are defined as articles that contain greater than 15% of a plurality of fibers that are continuous or non-continuous and physically and/or chemically attached to one another. The nonwoven may be combined with additional nonwovens or films to produce a layered product used either by itself or as a component in a complex combination of other materials, such as a baby diaper or feminine care pad. The resultant products may find use in filters for air, oil and water; vacuum cleaner filters; furnace filters; face masks; coffee filters, tea or coffee bags; thermal insulation materials and sound insulation materials; nonwovens for one-time use sanitary products such as diapers, feminine pads, tampons, and incontinence articles; textile fabrics for improved moisture absorption and softness of wear such as micro fiber or breathable fabrics; an electrostatically charged, structured web for collecting and removing dust; reinforcements and webs for hard grades of paper, such as wrapping paper, writing paper, newsprint, corrugated paper board, and webs for tissue grades of paper such as toilet paper, paper towel, napkins and facial tissue; medical uses such as surgical drapes, wound dressing, bandages, dermal patches; and dental uses such as dental floss and toothbrush bristles. The fibrous web may also include odor absorbents, termite repellants, insecticides, rodenticides, and the like, for specific uses. The resultant product absorbs water and oil and may find use in oil or water spill clean-up, or controlled water retention and release for agricultural or horticultural applications. The resultant fibers or fiber webs may also be incorporated into other materials such as saw dust, wood pulp, plastics, and concrete, to form composite materials, which can be used as building materials such as walls, support beams, pressed boards, dry walls and backings, and ceiling tiles; other medical uses such as casts, splints, and tongue depressors; and in fireplace logs for decorative and/or burning purpose. Preferred articles of the present invention include disposable nonwovens for hygiene and medical applications. Hygiene applications include such items as wipes, diapers, feminine pads, and tampons.

### Films

A composition as disclosed herein can be formed into a film and can comprise one of many different configurations, depending on the film properties desired. The properties of the film can be manipulated by varying, for example, the thickness, or in the case of multilayered films, the number of layers, the chemistry of the layers, i.e., hydrophobic or hydrophilic, and the types of polymers used to form the polymeric layers. The films disclosed herein can have a thickness of less than 300 μm, or can have a thickness of 300 μm or greater. Typically, when films have a thickness of 300 μm or greater, they are referred to as extruded sheets, but it is understood that the films disclosed herein embrace both films (e.g., with thicknesses less than 300 μm) and extruded sheets (e.g., with thicknesses of 300 μm or greater).

The films disclosed herein can be multi-layer films. The film can have at least two layers (e.g., a first film layer and a second film layer). The first film layer and the second film layer can be layered adjacent to each other to form the multi-layer film. A multi-layer film can have at least three layers (e.g., a first film layer, a second film layer and a third film layer). The second film layer can at least partially overlie at least one of an upper surface or a lower surface of the first film layer. The third film layer can at least partially overlie the second film layer such that the second film layer forms a core layer. It is contemplated that multi-layer films can include additional layers (e.g., binding layers, non-permeable layers, etc.).

It will be appreciated that multi-layer films can comprise from about 2 layers to about 1000 layers; in certain embodiments from about 3 layers to about 200 layers; and in certain embodiments from about 5 layers to about 100 layers.

The films disclosed herein can have a thickness (e.g., caliper) from about 10 microns to about 200 microns; in certain embodiments a thickness from about 20 microns to about 100 microns; and in certain embodiments a thickness from about 40 microns to about 60 microns. For example, in the case of multi-layer films, each of the film layers can have a thickness less than about 100 microns less than about 50 microns; less than about 10 microns, or about 10 micron to about 300 micron. It will be appreciated that the respective film layers can have substantially the same or different thicknesses.

Thickness of the films can be evaluated using various techniques, including the methodology set forth in ISO 4593:1993, Plastics—Film and sheeting—Determination of thickness by mechanical scanning. It will be appreciated that other suitable methods may be available to measure the thickness of the films described herein.

For multi-layer films, each respective layer can be formed from a composition described herein. The selection of compositions used to form the multi-layer film can have an impact on a number of physical parameters, and as such, can provide improved characteristics such as lower basis weights and higher tensile and seal strengths. Examples of commercial multi-layer films with improved characteristics are described in U.S. Pat. No. 7,588,706.

A multi-layer film can include a 3-layer arrangement wherein a first film layer and a third film layer form the skin layers and a second film layer is formed between the first film layer and the third film layer to form a core layer. The third film layer can be the same or different from the first film layer, such that the third film layer can comprise a composition as described herein. It will be appreciated that similar film layers could be used to form multi-layer films having more than 3 layers. One embodiment for using multi-layer films is to control the location of the reclaimed polypropylene. For example, in a 3 layer film, the core layer may contain the reclaimed polypropylene while the outer layers do not. Alternatively, the inner layer may not contain the reclaimed polypropylene and the outer layers do contain the reclaimed polypropylene.

If incompatible layers are to be adjacent in a multi-layer film, a tie layer is preferably positioned between them. The purpose of the tie layer is to provide a transition and adequate adhesion between incompatible materials. An adhesive or tie layer is typically used between layers of layers that exhibit delamination when stretched, distorted, or deformed. The delamination can be either microscopic separation or macroscopic separation. In either event, the performance of the film may be compromised by this delamination. Consequently, a tie layer that exhibits adequate adhesion between the layers is used to limit or eliminate this delamination.

A tie layer is generally useful between incompatible materials. For instance, when a polyolefin and a copoly(ester-ether) are the adjacent layers, a tie layer is generally useful. The tie layer is chosen according to the nature of the adjacent materials, and is compatible with and/or identical to one material (e.g. nonpolar and hydrophobic layer) and a reactive group which is compatible or interacts with the second material (e.g. polar and hydrophilic layer). Suitable polymer backbones for the tie layer include polyethylene (low density—LDPE, linear low density—LLDPE, high density—HDPE, and very low density—VLDPE) and polypropylene.

The reactive group may be a grafting monomer that is grafted to this backbone, and is or contains at least one alpha- or beta-ethylenically unsaturated carboxylic acid or anhydrides, or a derivative thereof. Examples of such carboxylic acids and anhydrides, which maybe mono-, di-, or polycarboxylic acids, are acrylic acid, methacrylic acid, maleic acid, fumaric acid, itaconic acid, crotonic acid, itaconic anhydride, maleic anhydride, and substituted malic anhydride, e.g. dimethyl maleic anhydride. Examples of derivatives of the unsaturated acids are salts, amides, imides and esters e.g. mono- and disodium maleate, acrylamide, maleimide, and diethyl fumarate.

A particularly preferred tie layer is a low molecular weight polymer of ethylene with about 0.1 to about 30 weight percent of one or more unsaturated monomers which can be copolymerized with ethylene, e.g., maleic acid, fumaric acid, acrylic acid, methacrylic acid, vinyl acetate, acrylonitrile, methacrylonitrile, butadiene, carbon monoxide, etc. Preferred are acrylic esters, maleic anhydride, vinyl acetate, and methylacrylic acid. Anhydrides are particularly preferred as grafting monomers with maleic anhydride being most preferred.

An exemplary class of materials suitable for use as a tie layer is a class of materials known as anhydride modified ethylene vinyl acetate sold by DuPont under the tradename Bynel®, e.g., Bynel® 3860. Another material suitable for use as a tie layer is an anhydride modified ethylene methyl acrylate also sold by DuPont under the tradename Bynel®, e.g., Bynel® 2169. Maleic anhydride graft polyolefin polymers suitable for use as tie layers are also available from Elf Atochem North America, Functional Polymers Division, of Philadelphia, Pa. as Orevac™.

Alternatively, a polymer suitable for use as a tie layer material can be incorporated into the composition of one or more of the layers of the films as disclosed herein. By such incorporation, the properties of the various layers are modified so as to improve their compatibility and reduce the risk of delamination.

Other intermediate layers besides tie layers can be used in the multi-layer film disclosed herein. For example, a layer of a polyolefin composition can be used between two outer layers of a hydrophilic resin to provide additional mechanical strength to the extruded web. Any number of intermediate layers may be used.

Examples of suitable thermoplastic materials for use in forming intermediate layers include polyethylene resins such as low density polyethylene (LDPE), linear low density polyethylene (LLDPE), ethylene vinyl acetate (EVA), ethylene methyl acrylate (EMA), polypropylene, and poly(vinyl chloride). Preferred polymeric layers of this type have mechanical properties that are substantially equivalent to those described above for the hydrophobic layer.

In addition to being formed from the compositions described herein, the films can further include additional additives. For example, opacifying agents can be added to one or more of the film layers. Such opacifying agents can include iron oxides, carbon black, aluminum, aluminum oxide, titanium dioxide, talc and combinations thereof. These opacifying agents can comprise about 0.1% to about 5% by weight of the film; and in certain embodiments, the opacifying agents can comprise about 0.3% to about 3% of the film. It will be appreciated that other suitable opacifying agents can be employed and in various concentrations. Examples of opacifying agents are described in U.S. Pat. No. 6,653,523.

Furthermore, the films can comprise other additives, such as other polymers materials (e.g., a polypropylene, a polyethylene, a ethylene vinyl acetate, a polymethylpentene any combination thereof, or the like), a filler (e.g., glass, talc, calcium carbonate, or the like), a mold release agent, a flame retardant, an electrically conductive agent, an anti-static agent, a pigment, an antioxidant, an impact modifier, a stabilizer (e.g., a UV absorber), wetting agents, dyes, a film anti-static agent or any combination thereof. Film antistatic agents include cationic, anionic, and, preferably, nonionic agents. Cationic agents include ammonium, phosphonium and sulphonium cations, with alkyl group substitutions and an associated anion such as chloride, methosulphate, or nitrate. Anionic agents contemplated include alkylsulphonates. Nonionic agents include polyethylene glycols, organic stearates, organic amides, glycerol monostearate (GMS), alkyl di-ethanolamides, and ethoxylated amines.

The film as disclosed herein can be processed using conventional procedures for producing films on conventional coextruded film-making equipment. In general, polymers can be melt processed into films using either cast or blown film extrusion methods both of which are described in Plastics Extrusion Technology-2nd Ed., by Allan A. Griff (Van Nostrand Reinhold—1976).

Cast film is extruded through a linear slot die. Generally, the flat web is cooled on a large moving polished metal roll (chill roll). It quickly cools, and peels off the first roll, passes over one or more auxiliary rolls, then through a set of rubber-coated pull or “haul-off” rolls, and finally to a winder.

In blown film extrusion, the melt is extruded upward through a thin annular die opening. This process is also referred to as tubular film extrusion. Air is introduced through the center of the die to inflate the tube and causes it to expand. A moving bubble is thus formed which is held at constant size by simultaneous control of internal air pressure, extrusion rate, and haul-off speed. The tube of film is cooled by air blown through one or more chill rings surrounding the tube. The tube is next collapsed by drawing it into a flattened frame through a pair of pull rolls and into a winder.

A coextrusion process requires more than one extruder and either a coextrusion feedblock or a multi-manifold die system or combination of the two to achieve a multilayer film structure. U.S. Pat. Nos. 4,152,387 and 4,197,069, incorporated herein by reference, disclose the feedblock and multi-manifold die principle of coextrusion. Multiple extruders are connected to the feedblock which can employ moveable flow dividers to proportionally change the geometry of each individual flow channel in direct relation to the volume of polymer passing through the flow channels. The flow channels are designed such that, at their point of confluence, the materials flow together at the same velocities and pressure, minimizing interfacial stress and flow instabilities. Once the materials are joined in the feedblock, they flow into a single manifold die as a composite structure. Other examples of feedblock and die systems are disclosed in Extrusion Dies for Plastics and Rubber, W. Michaeli, Hanser, N.Y., 2nd Ed., 1992, hereby incorporated herein by reference. It may be important in such processes that the melt viscosities, normal stress differences, and melt temperatures of the material do not differ too greatly. Otherwise, layer encapsulation or flow instabilities may result in the die leading to poor control of layer thickness distribution and defects from non-planar interfaces (e.g. fish eye) in the multilayer film.

An alternative to feedblock coextrusion is a multi-manifold or vane die as disclosed in U.S. Pat. Nos. 4,152,387, 4,197,069, and 4,533,308, incorporated herein by reference. Whereas in the feedblock system melt streams are brought together outside and prior to entering the die body, in a multi-manifold or vane die each melt stream has its own manifold in the die where the polymers spread independently in their respective manifolds. The melt streams are married near the die exit with each melt stream at full die width. Moveable vanes provide adjustability of the exit of each flow channel in direct proportion to the volume of material flowing through it, allowing the melts to flow together at the same velocity, pressure, and desired width.

Since the melt flow properties and melt temperatures of polymers vary widely, use of a vane die has several advantages. The die lends itself toward thermal isolation characteristics wherein polymers of greatly differing melt temperatures, for example up to 175° F. (80° C.), can be processed together. Each manifold in a vane die can be designed and tailored to a specific polymer. Thus the flow of each polymer is influenced only by the design of its manifold, and not forces imposed by other polymers. This allows materials with greatly differing melt viscosities to be coextruded into multilayer films. In addition, the vane die also provides the ability to tailor the width of individual manifolds, such that an internal layer can be completely surrounded by the outer layer leaving no exposed edges. The feedblock systems and vane dies can be used to achieve more complex multilayer structures.

One of skill in the art will recognize that the size of an extruder used to produce the films as disclosed herein depends on the desired production rate and that several sizes of extruders may be used. Suitable examples include extruders having a 1 inch (2.5 cm) to 1.5 inch (3.7 cm) diameter with a length/diameter ratio of 24 or 30. If required by greater production demands, the extruder diameter can range upwards. For example, extruders having a diameter between about 2.5 inches (6.4 cm) and about 4 inches (10 cm) can be used to produce the films of the present invention. A general purpose screw may be used. A suitable feedblock is a single temperature zone, fixed plate block. The distribution plate is machined to provide specific layer thicknesses. For example, for a three layer film, the plate provides layers in an 80/10/10 thickness arrangement, a suitable die is a single temperature zone flat die with “flex-lip” die gap adjustment. The die gap is typically adjusted to be less than 0.020 inches (0.5 mm) and each segment is adjusted to provide for uniform thickness across the web. Any size die may be used as production needs may require, however, 10-14 inch (25-35 cm) dies have been found to be suitable. The chill roll is typically water-cooled. Edge pinning is generally used and occasionally an air knife may be employed.

For some coextruded films, the placement of a tacky hydrophilic material onto the chill roll may be necessary. When the arrangement places the tacky material onto the chill roll, release paper may be fed between the die and the chill roll to minimize contact of the tacky material with the rolls. However, a preferred arrangement is to extrude the tacky material on the side away from the chill roll. This arrangement generally avoids sticking material onto the chill roll. An extra stripping roll placed above the chill roll may also assist the removal of tacky material and also can provide for additional residence time on the chill roll to assist cooling the film.

An alternative method of making the multi-layer films as disclosed herein is to extrude a web comprising a material suitable for one of the individual layers. Extrusion methods as known to the art for forming flat films are suitable. Such webs may then be laminated to form a multi-layer film suitable for formation into a fluid pervious web using the methods discussed below. As will be recognized, a suitable material, such as a hot melt adhesive, can be used to join the webs to form the multi-layer film. A preferred adhesive is a pressure sensitive hot melt adhesive such as a linear styrene isoprene styrene (“SIS”) hotmelt adhesive, but it is anticipated that other adhesives, such as polyester of polyamide powdered adhesives, hotmelt adhesives with a compatibilizer such as polyester, polyamide or low residual monomer polyurethanes, other hotmelt adhesives, or other pressure sensitive adhesives could be utilized in making the multi-layer films of the present invention.

In another alternative method of making the films as disclosed herein, a base or carrier web can be separately extruded and one or more layers can be extruded thereon using an extrusion coating process to form a film. Preferably, the carrier web passes under an extrusion die at a speed that is coordinated with the extruder speed so as to form a very thin film having a thickness of less than about 25 microns. The molten polymer and the carrier web are brought into intimate contact as the molten polymer cools and bonds with the carrier web.

As noted above, a tie layer may enhance bonding between the layers. Contact and bonding are also normally enhanced by passing the layers through a nip formed between two rolls. The bonding may be further enhanced by subjecting the surface of the carrier web that is to contact the film to surface treatment, such as corona treatment, as is known in the art and described in Modern Plastics Encyclopedia Handbook, p. 236 (1994).

If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film can go through an additional post-extrusion step of adhesive or extrusion lamination to other packaging material layers to form a multi-layer film. If the film is a coextrusion of two or more layers, the film can still be laminated to additional layers of packaging materials, depending on the other physical requirements of the final film. “Laminations Vs. Coextrusion” by D. Dumbleton (Converting Magazine (September 1992), also discusses lamination versus coextrusion. The films contemplated herein can also go through other post extrusion techniques, such as a biaxial orientation process.

The films as disclosed herein can be formed into fluid pervious webs suitable for use as a topsheet in an absorbent article. As is described below, the fluid pervious web is preferably formed by macroscopically expanding a film as disclosed herein. The fluid pervious web contains a plurality of macroapertures, microapertures or both. Macroapertures and/or microapertures give the fluid pervious web a more consumer-preferred fiber-like or cloth-like appearance than webs apertured by methods such as embossing or perforation (e.g. using a roll with a multiplicity of pins) as are known to the art. One of skill in the art will recognize that such methods of providing apertures to a film are also useful for providing apertures to the films as disclosed herein. Although the fluid pervious web is described herein as a topsheet for use in an absorbent article, one having ordinary skill in the art will appreciate these webs have other uses, such as bandages, agricultural coverings, and similar uses where it is desirable to manage fluid flow through a surface.

The macro and microapertures are formed by applying a high pressure fluid jet comprised of water or the like against one surface of the film, preferably while applying a vacuum adjacent the opposite surface of the film. In general, the film is supported on one surface of a forming structure having opposed surfaces. The forming structure is provided with a multiplicity of apertures therethrough which place the opposed surfaces in fluid communication with one another. While the forming structure may be stationary or moving, a preferred embodiment uses the forming structure as part of a continuous process where the film has a direction of travel and the forming structure carries the film in the direction of travel while supporting the film. The fluid jet and, preferably, the vacuum cooperate to provide a fluid pressure differential across the thickness of the film causing the film to be urged into conformity with the forming structure and to rupture in areas that coincide with the apertures in the forming structure.

The film passes over two forming structures in sequence. The first forming structure being provided with a multiplicity of fine scale apertures which, on exposure to the aforementioned fluid pressure differential, cause formation of microapertures in the web of film. The second forming structure exhibits a macroscopic, three-dimensional cross section defined by a multiplicity of macroscopic cross section apertures. On exposure to a second fluid pressure differential the film substantially conforms to the second forming structure while substantially maintaining the integrity of the fine scale apertures.

Such methods of aperturing are known as “hydroformation” and are described in greater detail in U.S. Pat. Nos. 4,609,518; 4,629,643; 4,637,819; 4,681,793; 4,695,422; 4,778,644; 4,839,216; and 4,846,821, the disclosures of each being incorporated herein by reference. The apertured web can also be formed by methods such as vacuum formation and using mechanical methods such as punching. Vacuum formation is disclosed in U.S. Pat. No. 4,463,045, the disclosure of which is incorporated herein by reference. Examples of mechanical methods are disclosed in U.S. Pat. Nos. 4,798,604; 4,780,352; and 3,566,726, the disclosures of which are incorporated herein by reference

### IV. Compression Molding of Articles

Prior to testing, samples of either polypropylene powders or pellets were compression molded into square articles (with rounded corners) with the following dimensions: 30 mm wide×30 mm long×1 mm thick. Powder compositions were first densified at room temperature (ca. 20-23° C.) by cold pressing the powder into a sheet using clean, un-used aluminum foil as a contact-release layer between stainless steel platens. Approximately 0.85 g of either cold-pressed powder or pellets was then pressed into test specimens on a Carver Press Model C (Carver, Inc., Wabash, Ind. 46992-0554 USA) pre-heated to 200° C. using aluminum platens, unused aluminum foil release layers, and a stainless steel shim with a cavity corresponding to aforementioned dimensions of the square test specimens. Samples were heated for 5 minutes prior to applying pressure. After 5 minutes, the press was then compressed with at least 2 tons (1.81 metric tons) of hydraulic pressure for at least 5 seconds and then released. The molding stack was then removed and placed between two thick flat metal heat sinks for cooling. The aluminum foil contact release layers were then peeled from the sample and discarded. The flash around the sample on at least one side was peeled to the mold edge and then the sample was pushed through the form. Each test specimen was visually evaluated for voids/bubble defects and only articles with no defects in the a 0.7″ (17.78 mm) diameter area were used for further measurement.

### V. Test Methods

The test methods described herein are used to measure the properties of reclaimed polypropylene compositions and square test specimen articles. Specifically, the test methods described measure the color and translucency/clarity, the amount of elemental contamination (i.e. heavy metals), the amount of non-combustible contamination (i.e. inorganic fillers), the amount of volatile compounds that contribute to the malodor of reclaimed polypropylene, and the amount of polymeric contamination (i.e. polyethylene contamination in reclaimed polypropylene).

### Color and Opacity Measurement of Molded Articles:

The color and opacity/translucency of a polymer are important parameters that determine whether or not a polymer can achieve the desired visual aesthetics of an article manufactured from the polymer. Known reclaimed polymers, especially post-consumer derived reclaimed polymers, are typically dark in color and opaque due to residual pigments, fillers, and other contamination. Thus, improving the color and opacity profile of an article made from reclaimed polymer is an important factor for broadening the potential end uses of the reclaimed polypropylene compositions of the present invention versus prior art reclaimed polypropylene compositions.

The color of each square test specimen article was characterized using the International Commission on Illumination (CIE) L*, a*, b* three dimensional color space. The dimension L* is a measure of the lightness of a sample, with L*=0 corresponding to the darkest black sample and L*=100 corresponding to the brightest white sample. The dimension a* is a measure of the red or green color of a sample with positive values of a* corresponding with a red color and negative values of a* corresponding with a green color. The dimension b* is a measure of the blue or yellow color of a sample with positive values of b* corresponding with a blue color and negative values of b* corresponding with a yellow color. The L*a*b* values of each 30 mm wide×30 mm long×1 mm thick square test specimen sample were measured on a HunterLab model LabScan XE spectrophotometer (Hunter Associates Laboratory, Inc., Reston, Va. 20190-5280, USA). The spectrophotometer was configured with D65 as the standard illuminant, an observer angle of 10°, an area diameter view of 1.75″ (44.45 mm), and a port diameter of 0.7″ (17.78 mm).

The opacity of each article, which is a measure of how much light passes through the sample (i.e. a measure of the sample's translucency), was determined using the aforementioned HunterLab spectrophotometer using the contrast ratio opacity mode. Two measurements were made to determine the opacity of each sample. One to measure the brightness value of the sample backed with a white backing, Y_{WhiteBacking}, and one to measure the brightness value of the sample backed with a black backing, Y_{BlackBacking}. The opacity was then calculated from the brightness values using the following equation 2:

$$\% Opacity = \frac{{Y}_{Black Backing}}{{Y}_{White Backing}} * 100 \qquad ( II )$$

### Elemental Analysis of Compositions:

Known reclaimed polymers, including reclaimed polypropylene, often have unacceptably high concentrations of heavy metal contamination. The presence of heavy metals, for example lead, mercury, cadmium, and chromium, may prevent the use of reclaimed polypropylene in certain applications, such as food or drug contact applications or medical device applications. Thus, reducing the concentration of heavy metals is an important factor for broadening the potential end uses of reclaimed polypropylene compositions of the present invention versus prior art polypropylene compositions.

Elemental analysis was performed using Inductively Coupled Plasma Mass Spectrometry (ICP-MS). Test solutions were prepared in n=2 to n=6 depending on sample availability by combing ˜0.25 g sample with 4 mL of concentrated nitric acid and 1 mL of concentrated hydrofluoric acid (HF). The samples were digested using an Ultrawave Microwave Digestion protocol consisting of a 20 min ramp to 125° C., a 10 min ramp to 250° C. and a 20 min hold at 250° C. Digested samples were cooled to room temperature. The digested samples were diluted to 50 mL after adding 0.25 mL of 100 ppm Ge and Rh as the internal standard. In order to assess accuracy of measurement, pre-digestion spikes were prepared by spiking virgin polymer. Virgin polymer spiked samples were weighed out using the same procedure mentioned above and spiked with the appropriate amount of each single element standard of interest, which included the following: Na, Al, Ca, Ti, Cr, Fe, Ni, Cu, Zn, Cd, and Pb. Spikes were prepared at two different levels: a “low level spike” and a “high level spike”. Each spike was prepared in triplicate. In addition to spiking virgin polymer, a blank was also spiked to verify that no errors occurred during pipetting and to track recovery through the process. The blank spiked samples were also prepared in triplicate at the two different levels and were treated in the same way as the spiked virgin polymer and the test samples. A 9 point calibration curve was made by making 0.05, 0.1, 0.5, 1, 5, 10, 50, 100, and 500 ppb solutions containing Na, Al, Ca, Ti, Cr, Fe, Ni, Cu, Zn, Cd, and Pb. All calibration standards were prepared by dilution of neat standard reference solutions and 0.25 mL of 100 ppm Ge and Rh as the internal standard with 4 mL of concentrated nitric and 1 mL of concentrated HF. Prepared standards, test samples, and spiked test samples were analyzed using an Agilent's 8800 ICP-QQQMS, optimized according to manufacturer recommendations. The monitored m/z for each analyte and the collision cell gas that was used for analysis was as follows: Na, 23 m/z, H₂; Al, 27 m/z, H₂; Ca, 40 m/z, H₂; Ti, 48 m/z, H₂; Cr, 52 m/z, He; Fe, 56 m/z, H₂; Ni, 60 m/z; no gas; Cu, 65 m/z, no gas; Zn, 64 m/z, He; Cd, 112 m/z; H₂; Pb, sum of 206≧206, 207≧207, 208≧208 m/z, no gas; Ge, 72 m/z, all modes; Rh, 103 m/z, all modes. Ge was used as an internal standard for all elements <103 m/z and Rh was used for all elements >103 m/z.

### Residual Ash Content of Compositions:

Reclaimed polymers, including reclaimed polypropylene, contain various fillers, for example calcium carbonate, talcum, and glass fiber. While useful in the original application of the reclaimed polypropylene, these fillers alter the physical properties of a polypropylene in way that may be undesired for the next application of the reclaimed polypropylene. Thus, reducing the amount of filler is an important factor for broadening the potential end uses of the reclaimed polypropylene compositions of the present invention versus prior art polypropylene compositions.

Thermogravimetric analysis (TGA) was performed to quantify the amount of non-combustible materials in the sample (also sometimes referred to as Ash Content). About 5-15 mg of sample was loaded onto a platinum sample pan and heated to 700° C. at a rate of 20° C./min in an air atmosphere in a TA Instruments model Q500 TGA instrument. The sample was held isothermal for 10 min at 700° C. The percentage residual mass was measured at 700° C. after the isothermal hold.

### Odor Analysis of Compositions:

Odor sensory analysis was performed by placing about 3 g of each sample in a 20 mL glass vial and equilibrating the sample at room temperature for at least 30 min. After equilibration, each vial was opened and the headspace was sniffed (bunny sniff) by a trained grader to determine odor intensity and descriptor profile. Odor intensity was graded according to the following scale:

5=Very Strong

4=Strong

3=Moderate

2=Weak to Moderate

1=Weak

0=No odor

### Polymeric Contamination Analysis of Compositions:

Reclaimed polypropylene, especially reclaimed polypropylene originating from mixed-stream sources, may contain undesired polymeric contamination. Without wishing to be bound by any theory, polymeric contamination, for example polyethylene contamination in polypropylene, may influence the physical properties of the polypropylene due to the presence of heterogeneous phases and the resulting weak interfaces. Furthermore, the polymeric contamination may also increase the opacity of the polypropylene and have an influence on the color. Thus, measuring the amount of polymeric contamination can be an important factor when distinguishing reclaimed polypropylene compositions of the present invention from known polypropylene compositions.

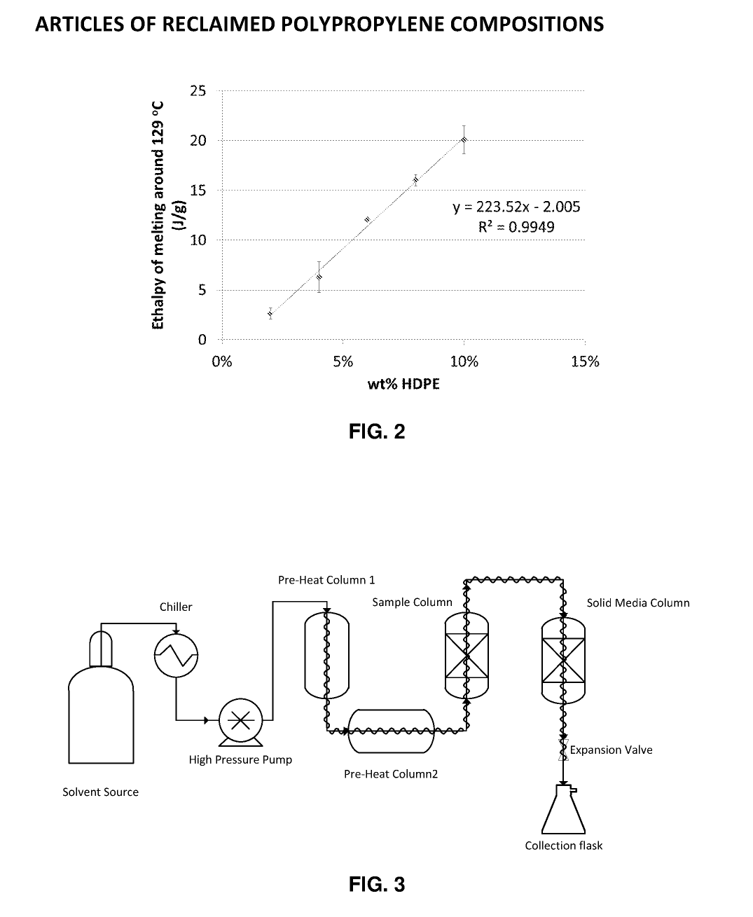

Semi-crystalline polymeric contamination was evaluated using Differential Scanning calorimetry (DSC). To measure the amount of polyethylene contamination in polypropylene, a set of five polypropylene/polyethylene blends were prepared with 2, 4, 6, 8, and 10 wt % of Formolene® HB5502F HDPE (Formosa Plastics Corporation, USA) in Pro-fax 6331 polypropylene (LyondellBasell Industries Holdings, B.V.). Approximately 5-15 mg of each sample was sealed in an aluminum DSC pan and analyzed on a TA Instruments model Q2000 DSC with the following method:
1. Equilibrate at 30.00° C.
2. Ramp 20.00° C./min to 200.00° C.
3. Mark end of cycle 0
4. Ramp 20.00° C./min to 30.00° C.
5. Mark end of cycle 1
6. Ramp 20.00° C./min to 200.00° C.
7. Mark end of cycle 2
8. Ramp 20.00° C./min to 30.00° C.
9. Mark end of cycle 3
10. Ramp 5.00° C./min to 200.00° C.
11. Mark end of cycle 4
   The enthalpy of melting for the HDPE peak around 128° C. was calculated for each sample of known HDPE content using the 5.00° C./min DSC thermogram. A linear calibration curve, shown in FIG. 2, was established plotting enthalpy of melting versus known HDPE concentration (wt %).

Samples having unknown PE content were analyzed using the same aforementioned DSC equipment and method. PE content was calculated using the aforementioned calibration curve. The specific HDPE used to generate the calibration curve will more than likely have a different degree of crystallinity than the polyethylene (or polyethylene blend) contamination that may be present in a reclaimed polypropylene sample. The degree of crystallinity may independently influence the measured enthalpy of melting for polyethylene and thus influence the resulting calculation of polyethylene content. However, the DSC test method described herein is meant to serve as a relative metric to compare compositions and is not meant to be a rigorous quantification of the polyethylene content in a polypropylene blend. While the aforementioned method described the measurement of polyethylene contamination in polypropylene, this method may be applied to measurement of other semi-crystalline polymers using different temperature ranges and peaks in the DSC thermogram. Furthermore, alternative methods, such as nuclear magnetic resonance (NMR) spectroscopy, may also be used to measure the amount of both semi-crystalline and amorphous polymeric contamination in a sample.

### VI. Article Test Methods

### Properties of Molded Articles:

Environmental Stress Cracking (ESC) is the premature initiation of cracking and embrittlement of a plastic due to the simultaneous action of stress, strain, and contact with specific chemical environments. One method of determining ESC is by using ASTM D-2561. An article of the invention can survive a 4.5 kilogram load under 60° C. for 15 days, preferably for 30 days, when subjected to ASTM D-2561.

Alternatively, the ESC can be determined according to the following procedure. A container to be tested is filled with liquid to a target fill level and, optionally, a closure is fitted on the container. If the closure is a screw type closure, it is tightened to a specified torque. The test container is conditioned for four hours under 50° C.+1.5° C. The screw-type container caps are then re-torqued to the original specified torque level and leaking samples are eliminated. At its conditioning temperature, the container is placed in an upright position and a 4.5 to 5.0 kilogram weight is placed on top of it. The container is inspected every day for thirty days for evidence of stress cracking or signs of leakage that may indicate stress cracking. A container of the invention can survive a 4.5 to 5.0 kilogram load for about thirty days, during which the first fifteen days are the most critical.

The Column Crush test provides information about the mechanical crushing properties (e.g., crushing yield load, deflection at crushing yield load, crushing load at failure, apparent crushing stiffness) of blown thermoplastic articles. When an empty, uncapped, air vented container of the invention is subjected to the ASTM D-2659 Column Crush test using a velocity of 50 mm/min, the compression strength peak force (at a deflection of no more than about 5 mm), is no less than about 50 N, preferably no less than about 100 N, more preferably no less than about 230 N. Also, when the container of the invention is tested filled with water at a temperature between 28° C. and 42° C. and subjected to the ASTM D-2659 Column Crush test using a velocity of 12.5 mm/min, the compression strength peak force (at a deflection of no more than about 5 mm), is no less than about 150 N, preferably no less than about 250 N, more preferably no less than about 300 N. The Column Crush tests are performed in a room held at room temperature.

The Full Notch Creep Test (FNCT) is an accelerated test used to assess the resistance of a polymer to slow crack growth in a chosen environment. When subjected to the FNCT described in ISO 16770, container of the present invention can survive at least about 4 hours, preferably at least about 18 hours, more preferably at least about 50 hours, even more preferably about 100 hours at an applied stress of about 4.4 MPa, at room temperature.

In some embodiments, molded articles contain a hinge, also called a living hinge. Hinge life is the ability of a hinge to sustain multiple openings by a person or a machine. If the hinge life of the cap is tested manually, the cap of the invention can sustain at least about 150, preferably at least about 200, more preferably at least about 300 openings by the person at room temperature. If the hinge life of the cap is tested by machine, it can sustain at least about 1500, preferably at least about 1700, more preferably at least about 2000 openings by the machine at room temperature. After each test, the hinge region is inspected for breakages.

Drop impact resistance is the ability of a molded article to survive a fall. To determine drop impact resistance, a molded article is dropped from a height of about 1.2 m. After each drop, the article is inspected for breakages.

### Properties of Films:

Tensile strength can be measured in a variety of ways, including an evaluation of the tensile strength at either 10% elongation or at break. One standard to apply in measuring tensile strength is the methodology set forth in ISO 527-5:2009, Plastics-Determination of tensile properties. In order to apply the methodology of ISO 527-5:2009, a sample size of 25.4 mm (or 1 inch) of a film as disclosed herein is placed under pressure by a clamping mechanism, such that a grip distance of about 50 mm is established. Next, the sample is subject to a testing speed of about 500 mm/min such that sufficient force is placed on the sample to stretch it accordingly. Using various modeling techniques and measuring the displacement of the sample under pressure, a model can be developed calculating the tensile strength associated with the sample of the film. The results of the modeling can then be evaluated pursuant to the parameters set forth in the ISO 527-5:2009 permitting calculation of the tensile strength at both 10% elongation and at break. It will be appreciated that other suitable techniques may be available by which to measure tensile strength of a film.

The seal strength of films can be measured using a variety of techniques, including the methodology set forth in ISO 527-5:2009. To apply the methodology of ISO 527-5:2009, a sample size of 25.4 mm (or 1 inch) of a film as disclosed herein is prepared, wherein the sample includes a seal extending along the mid-region of the sample. The “seal” can include any region where one edge of the film has been joined with another edge of the same (or different) film. It will be appreciated that this seal can be formed using a variety of suitable techniques (e.g., heat sealing). The sample can then be placed under pressure by a clamping mechanism, such that a grip distance of about 50 mm is established and the seal is placed between the grip distance. Next, the sample is subject to a testing speed pursuant to ISO 527-5:2009 such that sufficient force is placed on the sample to stretch it accordingly. Using various modeling techniques, the seal strength associated with the sample of the multi-layer film can be measured. The results of the modeling can then be evaluated pursuant to the parameters set forth in the ISO 527-5:2009. It will be appreciated that other suitable techniques may be available by which to measure seal strength of a film.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

A square test specimen article was compression molded from a sample of post-consumer derived recycled polypropylene mixed color flake that was sourced from a supplier of recycled resins. The post-consumer recycled polypropylene originated from the United States and Canada. The as-received mixed color flake was homogenized via compounding on a Century/W&P ZSK30 twin screw extruder equipped with two 30 mm general purpose screws each with standard mixing and conveying elements. The screw rotation speed was about 50 rpm, the feeder throughput was about 20 lbs/hour (9.07 kg/hr) and the temperature of the barrel ranged from about 210° C. at the die to about 150° C. at the feed throat. The gray strand exiting the extruder was cooled in room-temperature water bath, dried with air, and chopped into pellets.

The composition and resulting square test specimen article was characterized using the test methods disclosed herein and the resulting data are summarized in Table 1. The purpose of this example is to show the properties of an article molded from a representative composition of post-consumer derived recycled resin.

The pellets and corresponding square test specimen articles were dark gray in color as indicated in the L*a*b* values of the square test specimens. The opacity of the test specimens averaged about 100% opaque (i.e. no translucency).

The elemental (i.e. heavy metal) contamination was measured in the composition used to prepare the square test specimen in this example. The heavy metal contamination in this example serves as a representative baseline for elemental contamination found in post-consumer derived recycled polypropylene. When compared to other examples, the heavy metal contamination was found to be much greater in the as-received post-consumer derived recycled polypropylene. The concentration of aluminum in the samples of example 1 averaged to 192,000 ppb (192 ppm). The concentration of titanium averaged to 2,800,000 ppb (2,800 ppm). The concentration of zinc averaged to 71,000 ppb (71.0 ppm). The concentration of sodium averaged to 136,000 ppb (136 ppm). The concentration of calcium averaged to 1,590,000 ppb (1,590 ppm). The concentration of chromium averaged to 4,710 ppb (4.71 ppm). The concentration of iron averaged to 108,000 ppb (108 ppm). The concentration of nickel averaged to 1,160 ppb (1.16 ppm). The concentration of copper averaged to 15,300 ppb (15.3 ppm). The concentration of cadmium averaged to 1,620 ppb (1.62 ppm). The concentration of lead averaged to 12,200 ppb (12.2 ppm).

The composition used to mold the articles of example 1 had ash content values that averaged to about 1.2117 wt %, which also serves as a baseline for the amount of non-combustible substances that are often present in post-consumer derived recycled polypropylene.

This example also serves as a representative baseline for odor compound contamination found in post-consumer derived recycled polypropylene. The composition used to mold the articles of example 1 were found to have an odor intensity of 3.75 on a 5 point scale (5 being most intense), and were described as having a “garbage”, “dusty”, or “sour” odor.

This example also serves as a representative baseline for polyethylene contamination found in post-consumer derived recycled polypropylene. The composition used to mold the articles of example 1 had polyethylene contents that averaged to about 5.5 wt %.

### Example 2

A square test specimen article was compression molded from a composition of reclaimed polypropylene purified according to the method described herein. Prior to compression molding, the sample of post-consumer derived recycled polypropylene mixed color flake described in Example 1 was processed using the experimental apparatus shown in FIG. 3 and the following procedure:
1. 237 g of the mixed color flake was loaded into a 1.1 L extraction column pressure vessel with an internal diameter (ID) of 1.75″ (4.45 cm) and a length of 28″ (71.12 cm) that was heated to an external skin temperature of 175° C.
2. Liquid n-butane solvent was pressurized to about 2,150 psig (14.82 MPa) using a positive displacement pump and pre-heated to a temperature of about 110° C. using two heat exchangers before it was introduced to the bottom of the extraction column.
3. The fluid stream leaving the top of the extraction column was introduced into the top of a second 0.5 L pressure vessel with an ID of 2″ (5.08 cm) and a length of about 8.5″ (21.59 cm) that was heated to an external skin temperature of 175° C. The second pressure vessel contained 150 mL of silica gel (Silicycle Ultra Pure Silica Gels, SiliaFlash GE60, Parc-Technologies, USA) that was pre-mixed in a beaker with 150 mL of aluminum oxide (Activated Alumina, Selexsorb CDX, 7×14, BASF, USA).
4. The fluid stream leaving the bottom of the second pressure vessel was depressurized across an expansion valve into a side-arm Erlenmeyer flask. After depressurizing the fluid stream into the Erlenmeyer flask, the solvent vapor was vented through the side-arm port and any liquids/solids were collected in the flask. The n-butane solvent was eluted through the system at 2,150 psig (14.82 MPa) until no further material was observed accumulating in the flask. 19.93 g of white solids were collected and labeled ‘Fraction 1’.
5. The Erlenmeyer flask was replaced with an empty, clean flask and the system pressure was then increased to 2,400 psig (16.55 MPa).
6. The system pressure was maintained at 2,400 psig (16.55 MPa) until no further solid material was observed eluting from the system. 89.35 g of white solids were collected and labeled ‘Fraction 2’.
7. The Erlenmeyer flask was replaced with an empty, clean flask and the system pressure was then increased to 2,500 psig (17.24 MPa).
8. The system pressure was maintained at 2,500 psig (17.24 MPa) until no further solid material was observed eluting from the system. 58.18 g of white solids were collected and labeled ‘Fraction 3’.
9. The Erlenmeyer flask was replaced with an empty, clean flask and the system pressure was then increased to 2,600 psig (17.93 MPa).
10. The system pressure was maintained at 2,600 psig (17.93 MPa) until no further solid material was observed eluting from the system. 7.29 g of white solids were collected and labeled ‘Fraction 4’.
11. The Erlenmeyer flask was replaced with an empty, clean flask and the system pressure was then increased to 3,000 psig (20.68 MPa).
12. The system pressure was maintained at 3,000 psig (20.68 MPa) until no further solid material was observed eluting from the system. 5.58 g of off-white solids were collected and labeled ‘Fraction 5’.
13. The samples collected in each flask were allowed to degas at room temperature and pressure for at least two days before being characterized using the test methods disclosed herein.

The white solid material collected at 2,400 psig (16.55 MPa) as Fraction 2 was compression molded into square test specimen articles. Test method data collected for this example are summarized in Table 1.

The solids isolated in fractions 1-5 in this example were white in color. When the white solids from fraction 2 were compression molded into square test specimen articles, the specimens were colorless and clear and similar in appearance to articles compression molded from virgin polypropylene. The L*a*b* values showed that the square test specimen articles were essentially colorless and showed a dramatic improvement in color relative to the square test specimen articles of example 1 (i.e. as-received post-consumer derived polypropylene). The L* values for the square test specimen articles from fraction 2 of example 2 averaged 85.29 which were much improved when compared to the L* values for the square test specimen articles of example 1, which averaged 39.76. The opacity for the square test specimen articles from fraction 2 of example 2, which averaged 7.90% opaque (i.e. about 92% translucent), were also much improved when compared to the opacity values for the square test specimen articles of example 1, which averaged about 100% opaque.

The concentration of heavy metal contamination in the compositions used to mold the articles of example 2 were much improved and significantly lower when compared to the concentration of heavy metals in the compositions used to mold the articles of example 1. The concentration of aluminum was below the limit of quantitation. The concentration of titanium averaged to 638 ppb (0.638 ppm). The concentration of zinc averaged to 261 ppb (0.261 ppm). The concentration of sodium averaged to 2,630 ppb (2.63 ppm). The concentration of calcium averaged to 2,680 ppb (2.68 ppm). The concentration of chromium averaged to 17.5 ppb (0.0175 ppm). The concentration of iron was below the limit of quantitation. The concentration of nickel averaged to 10.9 ppb (0.0109 ppm). The concentration of copper averaged to 33.0 ppb (0.0330 ppm). The concentration of cadmium was below the limit of quantitation. The concentration of lead was below the limit of quantitation.

The compositions used to mold the articles of example 2 had ash content values that averaged to about 0.2897 wt %, which were significantly lower than the ash content values for the compositions used to mold the articles of example 1, which averaged to about 1.2117 wt %.

The compositions used to mold the articles of example 2 were found to have an odor intensity of 0.5 on a 5 point scale (5 being most intense), which was much improved when compared to the odor intensity of the compositions used to mold the articles of example 1, which had an odor intensity of 3.75. Though low in odor intensity, the compositions used to mold the articles of example 2 were described as having a “plastic” or “gasoline” like odor similar in character to virgin polypropylene.

Any polyethylene content in the compositions used to mold the articles of example 2 was below the limit of quantitation, which was much improved when compared to the polyethylene content of the compositions used to mold the articles of example 1, which averaged to about 5.5 wt %.

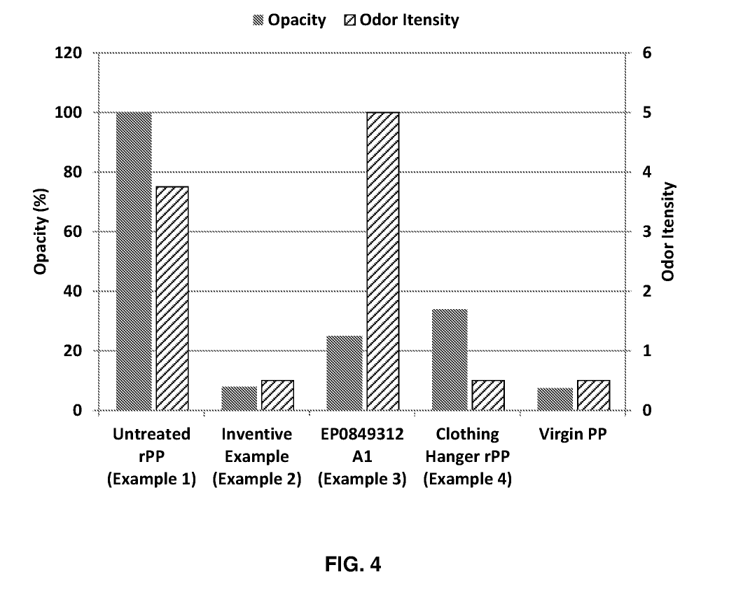

FIG. 4 is a bar chart of the opacity and odor intensity of the purified recycled polypropylene used to mold the articles of example 2 compared to the untreated recycled polypropylene used to mold the articles of example 1, the recycled polypropylene treated according to method disclosed in EP0849312 A1 used to mold the articles of example 3, a sample of recycled polypropylene from clothing hangers used to mold the articles of example 4, and a virgin polypropylene used to mold a comparative article sample. As shown in FIG. 4, the purified recycled polypropylene used to mold the articles of example 2 had both a low opacity and a low odor intensity and was similar to the virgin polypropylene used to mold a comparative sample.

### Example 3

A square test specimen article was compression molded from a composition of reclaimed polypropylene purified according to a procedure described in EP0849312 A1. Prior to compression molding, the sample of post-consumer derived recycled polypropylene mixed color flake described in Example 1 was purified using the procedure described below (based on the procedure described in EP0849312 A1).

20.00 g of post-consumer derived recycled polypropylene mixed color flake was combined with 400.04 g of white spirits (Sigma-Aldrich, USA) in a 1 L round-bottomed flask. The mixture was held at room temperature for 22 hours with occasional stirring. The white spirits was then decanted from the polypropylene. 402.60 g of fresh white spirits was added to the flask containing the polypropylene. The mixture was then heated and held at 140° C. for 90 min under reflux. The resulting hot solution was vacuum filtered through a 70 mm ID Buchner funnel with a layer of glass wool as the filtration medium. About 300 mL of filtrate was collected and allowed to cool to room temperature. The resulting gray precipitate was isolated via vacuum filtration through a 70 mm ID Buckner funnel with shark skin filter paper. The gray precipitate was combined with 2.01 g of Fuller's earth (Sigma-Aldrich, USA) and 195.21 g of fresh white spirits in a 1 L round-bottomed flask and then heated and held at 140° C. for 30 min under reflux. The resulting hot solution was vacuum filtered through a 5.5 cm ID Buchner funnel with shark skin filter paper. The filtrate was allowed to cool to room temperature. The resulting light gray precipitate was isolated via vacuum filtration through a 5.5 cm ID Buchner funnel with shark skin filter paper. The isolated precipitate was dried in a vacuum oven at 25° C. for about 18 hours. About 4.82 g of dried precipitate was isolated. The isolated precipitate was then extracted with acetone for 30 min using a Soxhlet extraction apparatus equipped with a cellulose extraction thimble. The extracted material was dried in a vacuum oven at 25° C. for about 19 hours. 3.4654 g of material was recovered. The resulting sample composition was characterized using the test methods disclosed herein and the resulting data are summarized in Table 1.

The solids isolated in this example were light gray to off-white in color. When these solids were compression molded into square test specimen articles, the specimens had a smoky, faint-gray appearance. The L*a*b* value showed the color of the article was improved relative to the articles of example 1 (i.e. as-received post-consumer derived polypropylene). The L* value for the article of example 3 was 63.15 which was improved when compared to the L* values for the articles of example 1, which averaged 39.76. However, the L* value for the article example 3 demonstrates that the method described in EP0849312 A1 does not produce an article that is as bright and colorless as the articles of example 2. The opacity of the article of example 3 was 24.96% opaque, which was improved when compared to the opacity values for the articles of example 1, which averaged about 100% opaque. The opacity value also shows that the article of example 3 was not as translucent as the articles of example 2.

The concentration of heavy metal contamination in the compositions used to mold the articles of example 3 was improved when compared to the compositions used to mold the articles of example 1, but higher in concentration when compared to the compositions used to mold the articles of example 2. The concentration of aluminum in the samples of example 3 averaged to 109,000 ppb (109 ppm). The concentration of titanium averaged to 64,100 ppb (64.1 ppm). The concentration of zinc averaged to 2,950 ppb (2.95 ppm). The concentration of sodium averaged to 5,120 ppb (5.12 ppm). The concentration of calcium averaged to 15,600 ppb (15.6 ppm). The concentration of chromium averaged to 757 ppb (0.757 ppm). The concentration of iron averaged to 55,700 ppb (55.7 ppm). The concentration of nickel averaged to 218 ppb (0.218 ppm). The concentration of copper averaged to 639 ppb (0.639 ppm). The concentration of cadmium averaged to 30.7 ppb (0.0307 ppm). The concentration of lead averaged to 121 ppb (0.121 ppm).

The compositions used to mold the articles of example 3 had an ash content of about 0.3294 wt %, which was lower than the ash content values for the compositions used to mold the articles of example 1, which averaged to about 1.2117 wt %.

The compositions used to mold the articles of example 3 had an odor intensity of 5 on a 5 point scale (5 being most intense), which was much stronger when compared to the odor intensity of the compositions used to mold the articles of example 1, which had an odor intensity of 3.75. The compositions used to mold the articles of example 3 had odor described as being like “gasoline.” The strong odor of this sample was due to the residual white sprits solvent used.

The compositions used to mold the articles of example 3 had average polyethylene content values of about 5.5 wt %, which was the same as the average polyethylene content of the compositions used to mold the articles of example 1, which also averaged to about 5.5. wt %. Thus, the method used to prepare the composition of example 3 did not remove a significant amount of polymeric contamination.

### Example 4

A square test specimen article was compression molded from a composition of reclaimed polypropylene that was sourced from recycled clothing hangers. The recycled clothing hanger polypropylene originated from the United States and was predominantly natural in color.

The L*a*b* values show that the articles of example 4 were natural in color, but not as bright as the articles of example 2. The L* for the article of example 4 was 82.03, while the L* for the articles of example 2 averaged 85.29. The article of example 4 was also more opaque than the articles of example 2. The opacity of the article of example 4 was 33.96, while the opacity of the articles of example 2 averaged 7.90.

The concentration of aluminum in the compositions used to mold the articles of example 4 averaged to 59,600 ppb (59.6 ppm). The concentration of titanium averaged to 62,200 ppb (62.2 ppm). The concentration of zinc averaged to 12,100 ppb (12.1 ppm). The concentration of sodium averaged to 20,200 ppb (20.2 ppm). The concentration of calcium averaged to 119,000 ppb (119 ppm). The concentration of chromium averaged to 92.7 ppb. The concentration of iron averaged to 9,370 ppb (9.37 ppm). The concentration of nickel was below the limit of quantitation. The concentration of copper averaged to 62.9 ppb (0.0629 ppm). The concentration of cadmium was below the limit of quantitation. The concentration of lead averaged to 30.1 ppb (0.0301 ppm).

The compositions used to mold the articles of example 3 had an ash content of about 0.3294 wt %, which was lower than the ash content values for the compositions used to mold the articles of example 1, which averaged to about 1.2117 wt %.

The compositions used to mold the articles of example 4 had an odor intensity of 0.5 on a 5 point scale (5 being most intense). The compositions used to mold the articles of example 3 had odor described as being like “plastic.”

Any polyethylene content in the compositions used to mold the articles of example 4 was below the limit of quantitation.

TABLE 1
Color, contamination, and odor of Examples 1-4

| | Example 1 | Example 2 | Example 3 | Example 4 |
|---|---|---|---|---|
| Color L* | 39.76 ± | 85.29 ± | 63.15 | 82.03 |
| | 0.24 | 0.17 | (n = 1) | (n = 1) |
| | (n = 3) | (n = 3) | | |
| Color a* | −2.51 ± | −0.69 ± | 0.27 | −1.58 |
| | 0.04 | 0.02 | (n = 1) | (n = 1) |
| | (n = 3) | (n = 3) | | |
| Color b* | −1.20 ± | 2.27 ± | 5.79 | 3.64 |
| | 0.11 | 0.08 | (n = 1) | (n = 1) |
| | (n = 3) | (n = 3) | | |
| Opacity (Y) | 100.19 ± | 7.90 ± | 24.96 | 33.96 |
| | 0.15 | 0.19 | (n = 1) | (n = 1) |
| | (n = 3) | (n = 3) | | |
| Na (ppb) | 136,000 ± | 2,630 ± | 5,120 ± | 20,200 ± |
| LOQ = 100 ppb | 109,000 | 3130 | 410 | 191 |
| | (n = 6) | (n = 5) | (n = 2) | (n = 3) |
| Al (ppb) | 192,000 ± | <LOQ | 109,000 ± | 59,600 ± |
| LOQ = 1000 ppb | 17,300 | | 2,180 | 617 |
| | (n = 6) | | (n = 2) | (n = 3) |
| Ca (ppb) | 1,590,000 ± | 2,680 ± | 15,600 ± | 119,000 ± |
| LOQ = 1000 ppb | 79,500 | 2,439 | 312 | 425 |
| | (n = 6) | (n = 5) | (n = 2) | (n = 3) |
| Ti (ppb) | 2,800,000 ± | 638 ± | 64,100 ± | 62,200 ± |
| LOQ = 100 ppb | 28,000 | 70 | 135 | 597 |
| | (n = 6) | (n = 5) | (n = 2) | (n = 3) |
| Cr (ppb) | 4,710 ± | 17.5 ± | 757 ± | 92.7 ± |
| LOQ = 10 ppb | 612 | 20.5 | 204 | 1.12 |
| | (n = 6) | (n = 5) | (n = 2) | (n = 3) |
| Fe (ppb) | 108,000 ± | <LOQ | 55,700 ± | 9,370 ± |
| LOQ = 1000 ppb | 1,080 | | 557 | 2,849 |
| | (n = 6) | | (n = 2) | (n = 3) |
| Ni (ppb) | 1,160 ± | 10.9 ± | 218 ± | <LOQ |
| LOQ = 10 ppb | 151 | 7.3 | 0.196 | |
| | (n = 6) | (n = 5) | (n = 2) | |
| Cu (ppb) | 15,300 ± | 33.0 ± | 639 ± | 62.9 ± |
| LOQ = 10 ppb | 612 | 17.2 | 345 | 6.00 |
| | (n = 6) | (n = 5) | (n = 2) | (n = 3) |
| Zn (ppb) | 71,000 ± | 261 ± | 2,950 ± | 12,100 ± |
| LOQ = 10 ppb | 1,420 | 183 | 443 | 301 |
| | (n = 6) | (n = 5) | (n = 2) | (n = 3) |
| Cd (ppb) | 1,620 ± | <LOQ | 30.7 ± | <LOQ |
| LOQ = 10 ppb | 113 | | 1.23 | |
| | (n = 6) | | (n = 2) | |
| Pb (ppb) | 12,200 ± | <LOQ | 121 ± | 30.1 ± |
| LOQ = 10 ppb | 243 | | 0.061 | 1.04 |
| | (n = 6) | | (n = 2) | (n = 3) |
| Ash Content | 1.2117 ± | 0.2897 ± | 0.3294 ± | 0.3706 ± |
| (% res from | 0.1501 | 0.1533 | 0.0948 | 0.0905 |
| TGA) | (n = 3) | (n = 3) | (n = 3) | (n = 2) |
| Odor Intensity | 3.75 | 0.5 | 5 | 0.5 |
| (0-5) | | | | |
| Odor Descriptor | garbage, | plastic, | gasoline | plastic |
| | dusty, sour | gasoline | | |
| PE content | 5.5 ± | <LOQ | 5.5 ± | <LOQ |
| (wt %) DSC | 0.3% | | 0.1% | |
| method | (n = 3) | | (n = 3) | |
| LOQ = 1% | | | | |

### Virgin Polypropylene Comparative Samples

Pro-fax 6331 polypropylene (LyondellBasell Industries Holdings, B.V.) was used for all “Virgin PP” comparative samples. The pellets of virgin PP were processed into square test specimens according the method described herein. The L*a*b* values for the specimens made from virgin PP averaged to 85.13±0.18, −0.71±0.01, and 2.27±0.02, respectively The square test specimens had an average opacity of 7.56±0.21% opaque. The pellets of virgin PP had an odor intensity of 0.5 on a 5 point scale (5 being the most intense) and had odor described as being like “plastic.”

Every document cited herein, including any cross reference or related patent or patent application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggest or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modification can be made without departing from the spirit and scope of the invention. It is therefore intended to cover in the appended claims all such changes and modification that are within the scope of the present invention.

What is claimed is:

1. An article comprising at least about 95 weight percent reclaimed isotactic polypropylene base resin comprising:
a. less than about 10 ppm Al;
b. less than about 5 ppm Ti; and
c. less than about 5 ppm Zn;
wherein said article is substantially free of odor and said base resin has a contrast ratio opacity of less than about 15%.

2. An article according to claim 1, wherein the article comprises post-consumer recycle derived reclaimed polypropylene.

3. An article according to claim 1, wherein the article comprises post-industrial recycle derived reclaimed polypropylene.

4. An article according to claim 1 comprising less than about 10 ppm Na.

5. An article according to claim 1 comprising less than about 20 ppm Ca.

6. An article according to claim 1 comprising less than about 2 ppm Cr.

7. An article according to claim 1 comprising less than about 7 ppm Fe.

8. An article according to claim 1 comprising less than about 100 ppb Ni.

9. An article according to claim 1 comprising less than about 50 ppb Cu.

10. An article according to claim 1 comprising less than about 10 ppb Cd.

11. An article according to claim 1 comprising less than about 10 ppb Pb.

12. An article according to claim 1 wherein the article has a contrast ratio opacity of less than about 10%.

13. An article according to claim 1 wherein the article has an odor intensity of less than about 2.

14. The article of claim 1, wherein said article is a fiber.

15. The article of claim 1, wherein said article is a nonwoven web of fibers.

16. The article of claim 1, wherein said article is a film.

17. The article of claim 1, wherein said article is a fluid pervious web formed from film.

18. The article of claim 1, wherein said article is a molded article.

19. The article of claim 18, wherein said molded article is in the form of a bottle, container, tub, closure, cap, lid, handle, dispenser, pump, part assembly, tampon applicator, sheet, pipe, or profile extrusion.

20. The article of claim 18, wherein said molded article is made by a method comprising compression molding.

21. The article of claim 18, wherein said molded article is made by a method comprising extrusion.

22. The article of claim 18, wherein said molded article is made by a method comprising blow molding.

23. The article of claim 18, wherein said molded article is made by a method comprising injection molding.

24. An article comprising at least about 95 weight percent reclaimed isotactic polypropylene comprising:
a. less than about 10 ppm Al;
b. less than about 5 ppm Ti; and
c. less than about 5 ppm Zn;
wherein said article is substantially color-free, substantially free of odor and has a contrast ratio opacity of less than about 15%.
